(19) United States
(12) Patent Application Publication
(10) Pub. No.: US 2016/0282906 A1
(43) Pub. Date: Sep. 29, 2016

(54) TRANSACTION PROCESSING SYSTEM, TRANSACTION PROCESSING METHOD AND TRANSACTION EQUIPMENT

(71) Applicant: PANASONIC INTELLECTUAL PROPERTY MANAGEMENT CO., LTD., Osaka (JP)

(72) Inventor: Ichiro HAGA, Fukuoka (JP)

(73) Assignee: PANASONIC INTELLECTUAL PROPERTY MANAGEMENT CO., LTD., Osaka (JP)

(21) Appl. No.: 15/077,180

(22) Filed: Mar. 22, 2016

(30) Foreign Application Priority Data
Mar. 27, 2015 (JP) 2015-067319
Apr. 16, 2015 (JP) 2015-084486
Apr. 17, 2015 (JP) 2015-085450

(51) Int. Cl. G06F 1/16; G09G 5/00; G06F 3/14; G06Q 20/16; G06F 13/40

(52) U.S. Cl. CPC G06F 1/1632; G06Q 20/16; G06F 13/4081; G06F 3/1454; G09G 5/005; G09G 2370/22; G09G 2358/00

(57) ABSTRACT

Transaction equipment switches from a monitor to an external display, and displays an operation screen of a settlement application or a business application, which is displayed on the monitor, on the external display through a docking device in response to the attachment of the transaction equipment to the docking device. When the own equipment is attached to the docking device, the transaction equipment detects a connection state of the external display to the docking device, performs an allocation setting such that first application A uses the external display in a case where the external display is connected, and performs an allocation setting such that second application B different from first application A uses an internal display in a case where the external display is not connected.

### BACKGROUND OF THE INVENTION

1. Field of the Invention

The present disclosure relates to a transaction processing system, a transaction processing method and transaction equipment used to perform at least one procedure of a merchandise registration process and a settlement process in a commercial transaction.

2. Description of the Related Art

In a store (for example, a convenience store), a merchandise registration process of registering merchandise items as sales targets in a commercial transaction (for example, merchandise sales, the same applies later) in a POS (Point Of Sales) terminal such as cash register is generally performed. For example, the POS terminal is a stationary type as in a POS terminal with a fixed scanner which is described in Japanese Patent Unexamined Publication No. 04-279995, and is fixedly provided in, for example, an exclusive counter of a store in many cases. In the POS terminal with a fixed scanner which is described in Japanese Patent Unexamined Publication No. 04-279995, a fixed scanner is supported by a supporting stand of the POS terminal through support means so as to be moved in upward and downward directions and forward, backward, leftward and rightward directions and so as to be tilted and rotated. In the merchandise registration process, a salesperson directly performs a touch input of merchandise items as sales targets on a touch panel provided at the POS terminal without using the fixed scanner, or performs a touch input of merchandise items displayed on a touch panel of portable transaction equipment in which an application for merchandise registration is installed so as to be executable in some cases.

For example, when a settlement process using a card (for example, a credit card) is performed in order to pay the amount of money required in the commercial transaction, in a case where an authorization inquiry about a owner of the card is performed and a response indicating that there are no particular problems with the authorization is obtained, the POS terminal transmits sales information to a settlement server (for example, a settlement center device operated by a settlement center or a settlement relay center device operated by a settlement relay center) connected to the POS terminal via a communication network (sales registration). In the settlement process, portable transaction equipment (for example, a settlement terminal) in which an application for a settlement process is installed so as to be executable and communication can be performed with the settlement server is used instead of the POS terminal in some cases.

For example, peripheral equipments such as a keyboard for inputting items or quantities of merchandises, a printer for printing a receipt related to the sales of the merchandises, a drawer for storing cash, and a display for displaying a sales amount of money to a customer are provided in, or are connected to the POS terminal provided in the store or near the POS terminal. Since the POS terminal is provided on the exclusive counter in the store, in order to improve operation convenience when the procedure of the merchandise registration process or the settlement process of the salesperson is performed, it is preferable to distinguish between a case where the portable transaction equipment and the peripheral equipment are used in cooperation with each other and a case where the transaction equipment is independently used.

For example, unlike the size of the display of the peripheral equipment, since there is a limitation on the size of a touch panel in view of portability of the transaction equipment, there is a problem that it is difficult to improve convenience at the time of the operation of the salesperson as the user due to the size of the screen of the application for merchandise registration application or the screen of the application for settlement process in a case where the transaction equipment is independently used. In a case where the portable transaction equipment and the display of the peripheral equipment are used in cooperation with each other, since it is necessary to previously perform a procedure of a use setting of the display, a complicated setting operation is required.

The portable transaction equipment using an information processing terminal can be freely carried, and it is possible to achieve high convenience in a case where the transaction equipment is independently used. However, in a case where the portable transaction equipment is used as stationary transaction equipment by being attached to the docking device, it is necessary to previously perform a procedure of a use setting of the peripheral equipment in order to cooperate with the peripheral equipment such as the display, and thus, a complicated setting operation is required. The operation is complicated in some cases in the way that the transaction equipment starts an application depending on a connection state of the transaction equipment with the peripheral equipment.

In general, a monitor that displays the screen of the above-described transaction equipment has a rectangular shape including long sides and short sides. The transaction equipment displays the screen of the application depending on various purposes such as a merchandise registration process and a settlement process, but the orientation of an appropriate screen is different depending on the application in some cases. For example, it is preferable that the application of the card settlement is displayed in a vertical orientation in many cases. Meanwhile, it is preferable that an application for maintenance of the equipment is displayed on a lateral orientation in many cases.

In a case where the orientation of a preferable screen is different depending on the application, it is considered that the user performs an operation input to change the orientation whenever an application to be displayed is changed. However, the user needs to perform such a troublesome and complicated operation in many cases.

### SUMMARY OF THE INVENTION

An object of the present disclosure is to improve convenience at the time of the operation of a user by displaying an operation screen wider than an operation screen of at least one of a merchandise registration process and a settlement process in a case where transaction equipment is independently used on peripheral equipment with a simple operation without requiring a complicated setting operation in a case where portable transaction equipment and peripheral equipment used in at least one procedure of the merchandise registration process and the settlement process are used in cooperation with each other.

An object of the present disclosure is also to improve convenience in a case where the portable transaction equipment is used as stationary transaction equipment by being attached to the docking device.

An object of the present disclosure is also to improve convenience by attaching the portable transaction equipment to the docking device or by appropriately setting an orientation of a screen of a monitor and controlling a complicated operation even in a case where the transaction equipment is detached from the docking device.

According to the present disclosure, there is provided transaction equipment or a transaction processing method in the transaction equipment including: an application controller that controls the execution of a predetermined application, and checks whether or not the transaction equipment is connected to a docking device connected to at least one peripheral equipment used in the application. The application controller sets the transaction equipment to be in an operation restriction state in which an operation is restricted in a case where the connection check fails.

According to the present disclosure, there is provided transaction equipment or a transaction processing method in the transaction equipment including: an application controller that controls the execution of a predetermined application, and checks whether or not the transaction equipment is connected to a docking device connected to at least one peripheral equipment used in the application. The application controller sets the transaction equipment to be in an operation restriction state in which an operation is restricted in a case where the connection check fails and the detachment of the transaction equipment from the docking device is not performed according to a predetermined procedure.

According to the present disclosure, there is provided transaction equipment or a transaction processing method in the transaction equipment including: an application controller that controls the execution of a predetermined application, and checks whether or not transaction equipment is connected to a docking device connected to at least one peripheral equipment used in the application. The application controller determines whether or not the detachment of the transaction equipment from the docking device is performed according to a predetermined procedure when the connection check fails, and changes the setting of the transaction equipment between a predetermined procedure case where the detachment is performed according to the predetermined procedure and an abnormality procedure case where the detachment is not performed according to the predetermined procedure.

According to the present disclosure, there is provided a transaction processing system including: portable transaction equipment; and a docking device which is capable of being connected to peripheral equipment used in a transaction process and is capable of being attached to and detached from the transaction equipment.

According to the present disclosure, it is possible to display an operation screen wider than an operation screen of at least one of a merchandise registration process and a settlement process in a case where transaction equipment is independently used on peripheral equipment with a simple operation without requiring a complicated setting operation in a case where portable transaction equipment and peripheral equipment used in one procedure of at least one of the merchandise registration process and the settlement process are used in cooperation with each other, and thus, it is possible to improve convenience at the time of the operation of the user.

According to the present disclosure, it is possible to improve convenience in a case where the portable transaction equipment is used as stationary transaction equipment by being attached to the docking device.

According to the present disclosure, a setting related to a state of whether or not the operation screen is rotated is changed between the time of the attachment of the transaction equipment to the docking device and the time of the detachment of the transaction equipment from the docking device. Therefore, the state of whether or not the operation screen of the transaction equipment is rotated becomes appropriate depending on a use situation, and thus, convenience is improved.

### BRIEF DESCRIPTION OF DRAWINGS

FIG. 1 is a diagram showing an example of the system configuration of a transaction processing system of the present exemplary embodiment;

FIG. 2 is a diagram for describing an example of a state in which transaction equipment is attached to or is detached from a docking device;

FIG. 3 is a diagram showing an example of a state in which the transaction equipment is attached to the docking device;

FIG. 4A is a diagram showing an example of the docking device in which an upper supporting part is rotated around a lower supporting part through a hinge in a tilt direction (arrow v1 direction);

FIG. 4B is a diagram showing an example of the docking device in which a holder rotation part rotates an equipment holder in an arrow v2 direction about 90 degrees from the position in the state of FIG. 4A;

FIG. 4C is a diagram showing an example of the docking device in which a rotatable pedestal is rotated in a panning direction (arrow v3 direction) from the position in the state of FIG. 3;

FIG. 5 is a diagram showing an example of the hardware configuration of the transaction equipment of the present exemplary embodiment;

FIG. 6 is a diagram showing an example of the hardware configuration of the docking device of the present exemplary embodiment;

FIG. 7A is a diagram showing a first example in which an operation screen of a card settlement application executable in the transaction equipment is displayed on a touch panel of the transaction equipment;

FIG. 7B is a diagram showing a second example in which the operation screen of the card settlement application executable in the transaction equipment is displayed on the touch panel of the transaction equipment;

FIG. 8 is a diagram showing an example in which an operation screen of a merchandise registration application executable in the transaction equipment is displayed on the touch panel of the transaction equipment;

FIG. 9 is a flowchart for describing a first example of an operation procedure of the transaction equipment of the present exemplary embodiment;

FIG. 10 is a flowchart for describing a second example of an operation procedure of the transaction equipment of the present exemplary embodiment;

FIG. 11 is a flowchart for describing a first example of an operation procedure of the docking device and an external display which receive display data shown in FIG. 10;

FIG. 12 is a flowchart for describing a first modification example of the operation procedure of the transaction equipment in a case where the transaction equipment is detached from the docking device;

FIG. 13 is a flowchart for describing a second modification example of the operation procedure of the transaction equipment in a case where the transaction equipment is detached from the docking device;

FIG. 14 is a flowchart for describing a third modification example of the operation procedure of the transaction equipment in a case where the transaction equipment is detached from the docking device;

FIG. 15 is a flowchart for describing a fourth modification example of the operation procedure of the transaction equipment in a case where the transaction equipment is detached from the docking device;

FIG. 16 is a flowchart for describing a third example of the operation procedure of the transaction equipment of the present exemplary embodiment;

FIG. 17 is a diagram showing an example of a table that defines a screen of an application displayed on an internal display of the transaction equipment in a case where the transaction equipment is detached from the docking device;

FIG. 18 is a diagram showing an example of an operation screen of a merchandise registration application displayed on the external display;

FIG. 19 is a diagram showing an example of an operation screen of a merchandise registration application displayed on the internal display of the transaction equipment;

FIG. 20 is a flowchart for describing a first example of the operation procedure of the transaction equipment of the present exemplary embodiment;

FIG. 21 is a flowchart for describing a second example of the operation procedure of the transaction equipment of the present exemplary embodiment;

FIG. 22 is a flowchart for describing a third example of the operation procedure of the transaction equipment of the present exemplary embodiment;

FIG. 23 is a flowchart for describing a fourth example of the operation procedure of the transaction equipment of the present exemplary embodiment;

FIG. 24 is a flowchart for describing a fifth example of the operation procedure of the transaction equipment of the present exemplary embodiment;

FIG. 25 is a diagram for describing a first example of the correspondence between an application and a connection state of peripheral equipment with the transaction equipment of the present exemplary embodiment;

FIG. 26 is a diagram for describing a second example of the correspondence between the application and the connection state of peripheral equipment with the transaction equipment of the present exemplary embodiment;

FIG. 27A is a flowchart for describing a first example of an operation of the transaction equipment in a case where the transaction equipment is attached to the docking device;

FIG. 27B is a diagram showing an example of an attachment table;

FIG. 28A is a flowchart for describing a first example of an operation of the transaction equipment in a case where the transaction equipment is detached from the docking device;

FIG. 28B is a diagram showing an example of a detachment table;

FIG. 29 is a flowchart for describing a second example of the operation of the transaction equipment in a case where the transaction equipment is attached to the docking device;

FIG. 30 is a flowchart for describing a second example of the operation of the transaction equipment in a case where the transaction equipment is detached from the docking device;

FIG. 31 is a flowchart for describing a third example of the operation of the transaction equipment in a case where the transaction equipment is attached to the docking device;

FIG. 32 is a flowchart for describing a third example of the operation of the transaction equipment in a case where the transaction equipment is detached from the docking device;

FIG. 33 is a diagram showing an example of a screen of an application of “maintenance”;

FIG. 34A is a diagram showing an example of a screen of an application of “merchandise inspection” in a lateral orientation;

FIG. 34B is a diagram showing an example of a screen of an application of “merchandise inspection” in a vertical orientation;

FIG. 35A is a diagram showing an example of a screen of an application of “inventory” in a lateral orientation; and

FIG. 35B is a diagram showing an example of a screen of an application of “inventory” in a vertical orientation.

### DETAILED DESCRIPTION OF THE PREFERRED EMBODIMENTS

Hereinafter, an exemplary embodiment (hereinafter, referred to as “present exemplary embodiment”) in which a transaction processing system, a transaction processing method, transaction equipment, and a program according to the present disclosure are specifically disclosed will be described in detail by appropriately referring to the drawings. Unnecessary descriptions may be omitted in some cases. For example, the detailed descriptions of the already well-known matters or the redundant descriptions of substantially the same configurations may be omitted in some cases. Such omissions are performed in order to allow a person skilled in the art to easily understand the present disclosure by preventing the following description from becoming unnecessarily redundant. The accompanying drawings and the following descriptions are provided to help a person skilled in the art fully understand the present disclosure, and thereby are not intended to limit the subject matter described in the claims.

### First Exemplary Embodiment

### System Configuration of Transaction Processing System

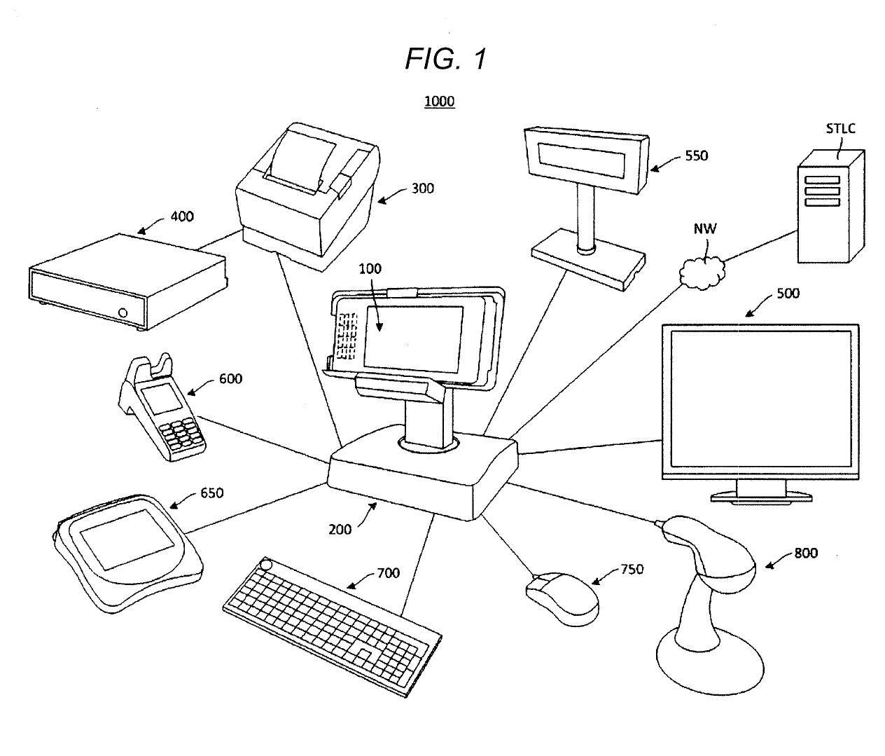

Initially, the system configuration of transaction processing system 1000 of the present exemplary embodiment will be described with reference to FIG. 1. FIG. 1 is a diagram showing an example of the system configuration of transaction processing system 1000 of the present exemplary embodiment. For example, transaction processing system 1000 shown in FIG. 1 is provided in a store such as a convenience store or a supermarket, and includes transaction equipment 100, docking device 200, receipt printer 300, cash drawer 400, external display 500, customer display 550, PINPAD 600, sign pad 650, keyboard 700, mouse 750, and barcode reader 800. Hereinafter, at least one of receipt printer 300, cash drawer 400, external display 500, customer display 550, PINPAD 600, sign pad 650, keyboard 700, mouse 750, and barcode reader 800 is referred to as “peripheral equipment” in some cases.

In transaction processing system 1000, docking device 200 on which transaction equipment 100 is mounted is connected to a settlement server (for example, a settlement relay center device operated by third party processor or a settlement center device operated by an issuer or an acquirer, to be described below) STLC in a settlement application which is installed to be executable in transaction equipment 100 via network NW.

Network NW is, for example, an intranet or the Internet. For example, the intranet is a wireless or wired local area network within the store in which transaction equipment 100 is provided. The internet is a network connected using the wireless network or the wired network as an interface. For example, the wireless network is a wireless LAN (Local Area Network), a wireless WAN (Wide Area Network), 3G, HSPA (High Speed Packet Access), LTE (Long Term Evolution), or WiGig (Wireless Gigabit). For example, the wired network is IEEE802.3/Ethernet (registered trademark). For example, network NW may be a wide area network established using 3G, HSPA or LTE, or may be a network established using an existing telephone line. Network NW may be established using another connection network such as an internet connection network through an access point which is a spot of Wifi (registered trademark). The Internet may be established using another connection network such as a dedicated line or an intranet.

The settlement relay center device is a server device for a settlement relay process in a third party processor (that is, a company which is requested a business from an issuer (a card issuing company) or an acquirer (a company that invites member stores which specific card transaction, and manages sales information based on the card transaction of the member store), and relays a settlement process from each member store). The settlement relay center device receives a request for sales registration or an authorization inquiry for the settlement process of a commercial transaction from transaction equipment 100 via network NW, inquires about the determination of whether or not to grant authorization by the settlement center device, and requests the processing of the sales registration by the settlement center device.

For example, settlement center device STLC2 is a server device for a settlement process which is operated by the issuer or the acquirer that directly fulfills member-store contracts with the member stores. The settlement center device sends the authorization result, the determination result of the authorization inquiry or the processing result of the sales registration to transaction equipment 100 through the settlement relay center device in response to the inquiry about the determination from the settlement relay center device. Settlement center device STLC2 may receive a request for the sales registration or the authorization inquiry of the settlement process of the commercial transaction from transaction equipment 100 via network NW, may perform the determination of whether or not to authorize, and may directly send the processing result of the sales registration or the determination result of the authorization inquiry to transaction equipment 100.

For example, transaction equipment 100 is a settlement terminal device, such as a tablet terminal which is easily held with one hand or both hands, which includes a portable housing and in which at least one of a settlement application and a general-purpose business application (for example, a merchandise registration application or a stock management application) required for the business in the store where transaction equipment 100 is provided is installed so as to be executable. Hereinafter, the transaction equipment may be referred to as MPOS (Mobile Point Of Sales) in some cases. Transaction equipment 100 receives information (settlement information) regarding various items related to the settlement process of a transaction using a card through touch panels TP2 and TP1 by a user (for example, a salesperson or a customer), and reads a card number and an expiration date of the card.

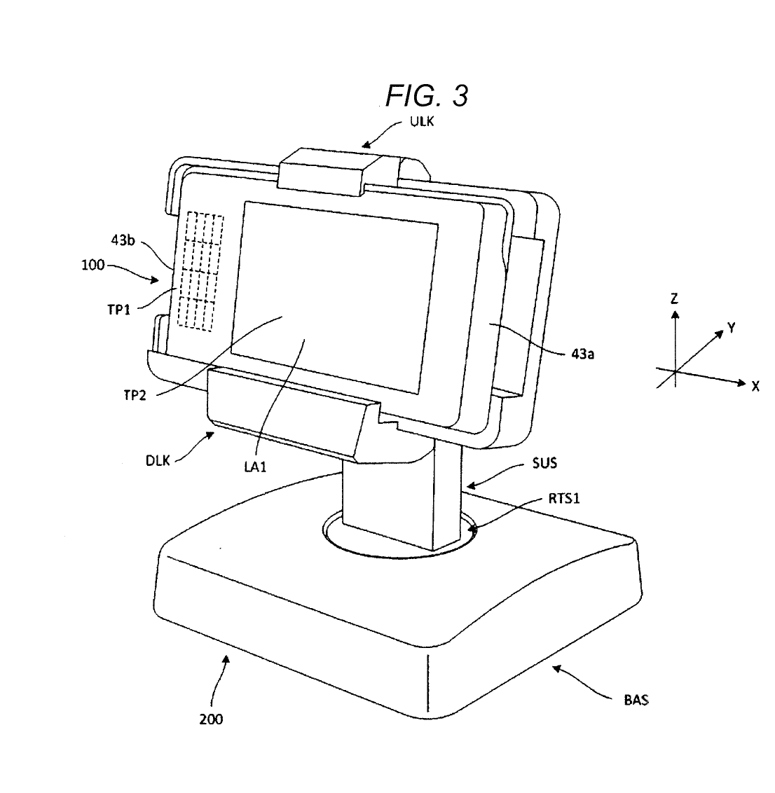

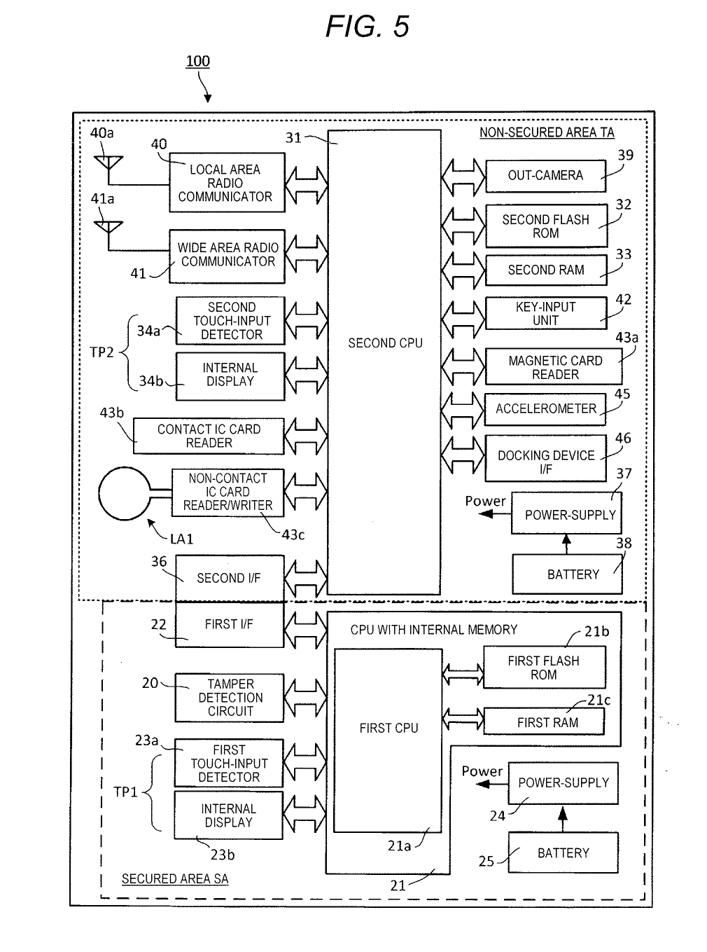

In a case where transaction equipment is attached to docking device 200 (see FIG. 3), transaction equipment (MPOS) 100 performs communication related to the settlement process of the commercial transaction using the card (for example, an IC credit card. The same applies later) with settlement server STLC (for example, the settlement relay center device or the settlement center device) via docking device 200 and network NW. Even in a case where transaction equipment is detached from docking device 200, transaction equipment 100 may perform the communication related to the settlement process of the commercial transaction using the card with settlement server STLC via the network. The specific configuration of transaction equipment 100 will be described with reference to FIG. 5.

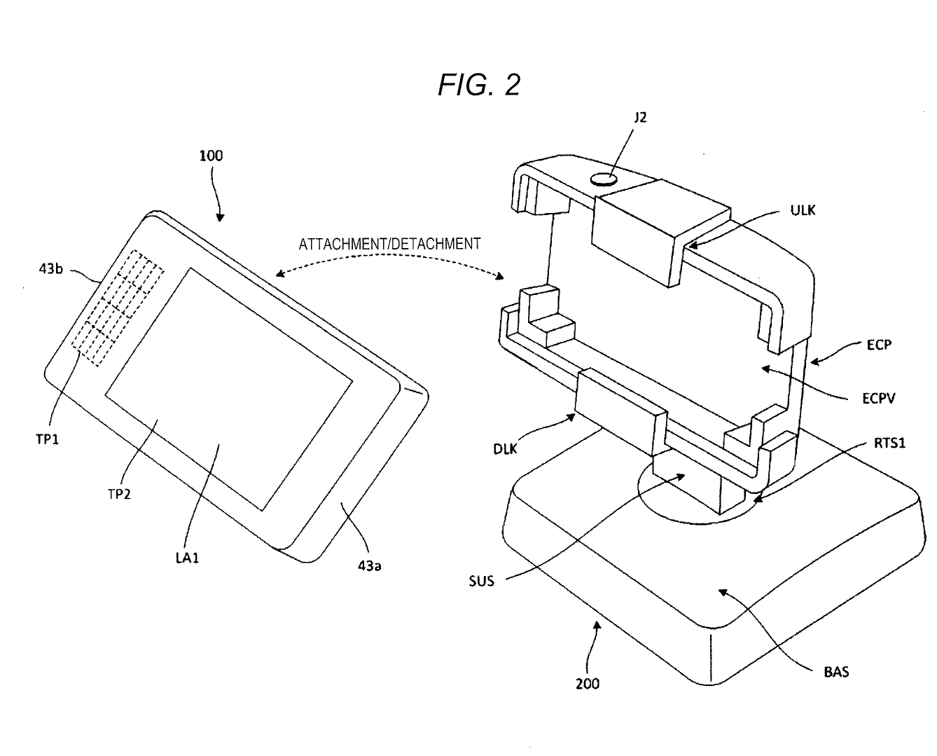

Docking device 200 is connected to at least one peripheral equipment (see FIG. 1) used in at least one of the settlement application and the general-purpose application installed in transaction equipment 100, and allows transaction equipment 100 to be attached and detached (see FIGS. 2 and 3).

Receipt printer 300 as an example of the peripheral equipment is connected to docking device 200 and cash drawer 400, and prints predetermined receipts by using print data regarding the predetermined receipts (for example, a customer receipt and a store receipt) output from docking device 200 in a case where the settlement related to the commercial transaction is normally ended. For example, in a case where the receipts are printed, receipt printer 300 switches a switch built in cash drawer 400 from an OFF state (a locked state) to an ON state (an unlocked state), and pushes cash drawer 400 in an opening direction, in response to a control signal from transaction equipment 100. In a case where transaction equipment 100 is attached to and is connected to docking device 200, the control signal is a signal which is transmitted from transaction equipment 100 and is received by docking device 200, and is transmitted to receipt printer 300 through docking device 200.

Cash drawer 400 as an example of the peripheral equipment is connected to only receipt printer 300, and strictly stores cash possessed in the store where transaction processing system 1000 is provided.

External display 500 as an example of the peripheral equipment is a display device which is connected to docking device 200 and has a display area greater than that of internal display 34b of transaction equipment 100. External display 500 may be a touch panel capable of detecting a touch input of the salesperson or the customer.

Customer display 550 as an example of the peripheral equipment is a display device which is connected to docking device 200 and has a display area having a predetermined size, and displays, for example, a sales amount of money (settlement amount of money) related to the commercial transaction of the customer in a direction in which the information can be easily seen by the customer. Customer display 550 may be a touch panel capable of detecting a touch panel of the salesperson or the customer.

PINPAD 600 as an example of the peripheral equipment is an input device which is connected to docking device 200 and allows the customer to input a PIN (Personal Identification Number) as authentication information for authenticating the customer as a legitimate owner of the card during the execution of the settlement application using the card.

Sign pad 650 as an example of the peripheral equipment is an input device which is connected to docking device 200 and allows the customer to input electronic data regarding a handwritten signature as authentication information for authenticating the customer as a legitimate owner of the card during the execution of the settlement application using the card.

Keyboard 700 as an example of the peripheral equipment is connected to docking device 200, and is used by the salesperson in order to input characters or numerals on an operation screen of an application executable in transaction equipment 100.

Mouse 750 as an example of the peripheral equipment is connected to docking device 200, and is used by the salesperson in order to select a specific item on an operation screen of an application executable in transaction equipment 100.

Barcode reader 800 as an example of the peripheral equipment is connected to docking device 200, and is used by the salesperson in order to read a barcode assigned to a merchandise or a coupon as a target of the commercial transaction.

Attachment and Detachment of Transaction Equipment to and from Docking Device

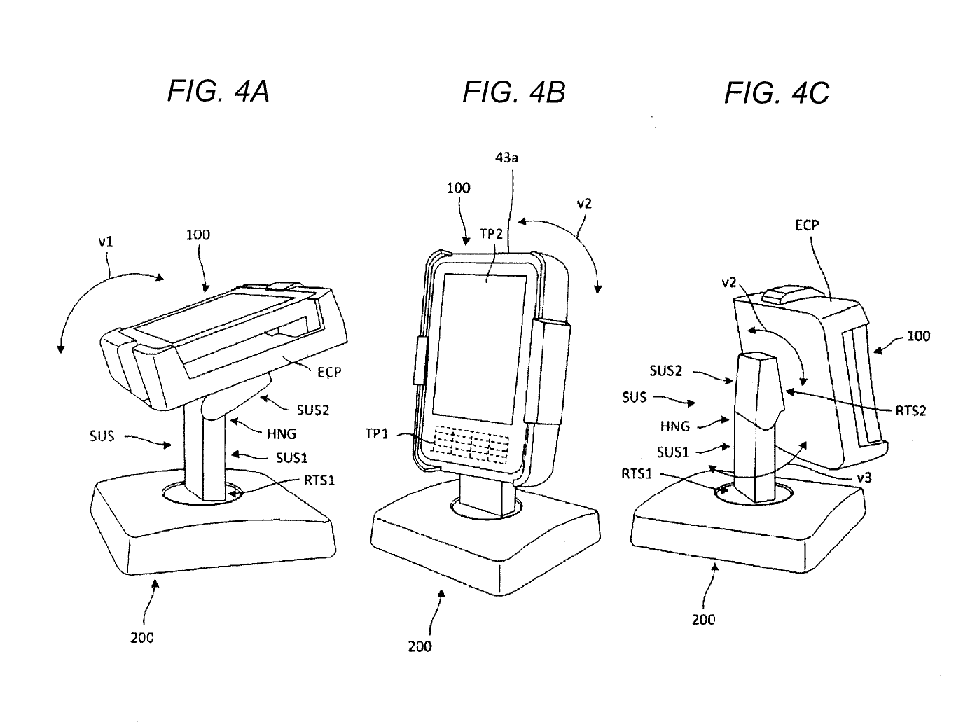

Hereinafter, the attachment and detachment of transaction equipment 100 to and from docking device 200 will be described with reference to FIGS. 2, 3, and 4A to 4C. FIG. 2 is a diagram for describing an example of a state in which transaction equipment 100 is attached to and is detached from docking device 200. FIG. 3 is a diagram showing an example of a state in which transaction equipment 100 is attached to docking device 200. FIG. 4A is a diagram showing an example of docking device 200 in which upper supporting part SUS2 is rotated around lower supporting part SUS1 in a tilt direction (arrow v1 direction) through hinge HNG. FIG. 4B is a diagram showing docking device 200 in which holder rotation part RTS2 rotates equipment holder ECP in an arrow v2 direction about 90 degrees from the position in the state of FIG. 4A. FIG. 4C is a diagram showing an example of docking device 200 in which rotatable pedestal RTS1 is rotated in a panning direction (arrow v3 direction) from the position in the state of FIG. 3.

For example, docking device 200 is disposed in a predetermined position of a checkout counter of the store, and includes equipment holder ECP supported by supporting part SUS which is erected upward from columnar rotatable pedestal RTS1, which is provided in a near central position of square-columnar fixing pedestal BAS, in a vertical direction. Rotatable pedestal RTS1 is rotated around fixing pedestal BAS about 180 degrees (see FIG. 4C). Equipment holder ECP includes upper locking part ULK, and lower locking part DLK, and holds and locks transaction equipment 100 in equipment holding space ECPV formed between upper locking part ULK and lower locking part DLK so as to expose transaction equipment 100. Locking part J2 is formed in upper locking part ULK, and if transaction equipment 100 is attached in equipment holding space ECPV of docking device 200 and then is locked by a tool such as a driver, upper locking part ULK and lower locking part DLK lock transaction equipment 100 so as to sandwich transaction equipment in both directions of an upward direction and a downward direction. Thus, transaction equipment 100 is physically attached to docking device 200.

In the case where the transaction equipment is attached to docking device 200 (see FIG. 3) and in the case where the transaction equipment is detached from the docking device (see FIG. 2), for example, transaction equipment 100 can receive an input operation of the salesperson on touch panel TP2 provided in non-secured area TA (see FIG. 5), and can receive an input operation of the customer on touch panel TP1 provided in secured area SA (see FIG. 5).

In transaction equipment 100, magnetic card reader 43a is provided on a side surface of the housing of transaction equipment 100 close to non-secured area TA, in a transverse direction, and contact IC card reader 43b is provided on a side surface of the housing of transaction equipment 100 close to secured area SA. Loop antenna LA1 connected to non-contact IC card reader/writer 43c, to be described below, is provided in a portion of the housing of transaction equipment 100 close to non-secured area TA (that is, a portion which is substantially parallel to touch panel TP2). In the case where the transaction equipment is attached to docking device 200 (see FIG. 3) and in the case where the transaction equipment is detached from the docking device (see FIG. 2), transaction equipment 100 can read a magnetic card in magnetic card reader 43a, can read a contact IC card in contact IC card reader 43b, and can read a non-contact IC card approaching near loop antenna LA1 in non-contact IC card reader/writer 43c through the operation of the salesperson.

As shown in FIGS. 4A to 4C, docking device 200 to which transaction equipment 100 is attached can be rotated in various directions. For example, as shown in FIG. 4A, in docking device 200, upper supporting part SUS2 can be rotated around lower supporting part SUS1 through hinge HNG in the tilt direction (arrow v1 direction). Supporting part SUS shown in FIG. 2 or 3 is configured such that lower supporting part SUS1 lower supporting part SUS1 which is erected from rotatable pedestal RTS1, hinge HNG which rotates upper supporting part SUS2 around lower supporting SUS1 in the tilt direction, and upper supporting part SUS2 which supports equipment holder ECP are sequentially connected (see FIG. 4A). Thus, the salesperson or the customer can easily input the operations on touch panels TP2 and TP1 by rotating docking device 200 such that touch panels TP2 and TP1 of transaction equipment 100 face a ceiling surface of the store.

As shown in FIG. 4B, in docking device 200, holder rotation part RTS2 (see FIG. 4C) can rotate equipment holder ECP in the arrow v2 direction about 90 degrees from the position in the state of FIG. 4A. Thus, since the salesperson or the customer can rotate touch panels TP2 and TP1 of transaction equipment 100 such that the longitudinal direction of the housing of transaction equipment 100 is parallel to the vertical direction, the salesperson or the customer can easily see the operation screen of the application including characters or numerals displayed on touch panels TP2 and TP1, and can easily operate the operation screen.

As shown in FIG. 4C, in docking device 200, rotatable pedestal RTS1 can be rotated in the panning direction (arrow v3 direction) from the position in the state of FIG. 3 (that is, a state in which transaction equipment 100 is attached to docking device 200). Thus, since the salesperson can turn the operation screen of the application displayed on touch panel TP2 of transaction equipment 100 toward the salesperson or the customer, the salesperson and the customer facing the salesperson can simply perform the operation on touch panel TP2.

### Configuration of Transaction Equipment

Hereinafter, the hardware configuration of transaction equipment 100 of the present exemplary embodiment will be described with reference to FIG. 5. FIG. 5 is a diagram showing an example of the hardware configuration of transaction equipment 100 of the present exemplary embodiment. Transaction equipment 100 shown in FIG. 5 has non-secured area TA and secured area SA. “Secure” mentioned herein means that the area has tamper resistance. “Non-secure” means that the area has no tamper resistance. “Tamper resistance” refers to resistance to illegal analysis and modification of software or hardware within equipment, illegal piracy and modification, of information within the equipment, and attack to allow the information to be disabled. That is, the tamper resistance refers to the difficulty of analyzing stored data or the internal structure of the hardware or the software. The area has the tramper resistance, and thus, information of a service receiver (for example, the customer) can be protected and the transaction can be safely performed.

In secured area SA, tamper detection circuit 20 that detects whether or not a physical unauthorized behavior (for example, breakage and damage of transaction equipment 100) is performed, CPU 21 with internal memory, first I/F (interface) 22, first touch-input detector 23a, internal display 23b, power-supply 24, and battery 25 are provided. First touch-input detector 23a and internal display 23b constitute touch panel TP1. In CPU 21 with internal memory, first CPU 21a, first flash ROM (Read Only Memory) 21b, and first RAM (Random Access Memory) 21c are provided.

In secured area SA, various components are electrically and logically connected to first CPU 21a. First CPU 21a manages all the components in secured area SA. For example, first CPU 21a performs various controls, processes, settings, determinations, checks, authentications, inquires (for example, an inquiry about PIN or signature), and instructions by executing programs stored in first flash ROM 21b.

First flash ROM 21b stores an encryption key used in communication with settlement server STLC (see FIG. 1, for example, the settlement relay center device or the settlement center device), personal information such as a PIN, confidential information such as settlement information regarding the settlement, or programs for transaction equipment 100 to receive a PIN input and an inquiry of the settlement. First flash ROM 21b is an example of a storage medium that stores programs and data for information processing in first CPU 21a.

For example, when processes associated with the reception of the PIN input and the inquiry of the settlement of transaction equipment 100 (for example, secured area SA) are performed, first RAM 21c is a work memory used to temporarily store processing data generated during the process.

Tamper detection circuit 20 constantly monitors secured area SA, and detects the physical unauthorized behavior (for example, the analysis, breakage or unsealing of secured area SA of transaction equipment 100) of secured area SA. In other words, tamper detection circuit 20 detects whether or not abnormality occurs in secured area SA. In a case where an event of the physical unauthorized behavior is detected by tamper detection circuit 20, CPU 21 with internal memory or second CPU 31 may forcibly stop the settlement process in the settlement application, or may notify that the physical unauthorized behavior is detected in secured area SA through at least one of touch panels TP1 and TP2.

First I/F 22 is provided to electrically connect non-secured area TA to secured area SA, and delivers various data items or commands between non-secured area TA and secured area SA through second I/F 36. First I/F 22 and second I/F 36 can be coupled to each other.

First touch-input detector 23a detects the touch input of the salesperson or the customer on touch panel TP1. For example, first touch-input detector 23a may detect an input on a PIN pad as a physical keypad or a software keyboard for inputting the PIN. For example, first touch-input detector 23a may detect a signature input using a finger or a stylus pen. For example, first touch-input detector 23a may detect a handwritten input of the PIN by using a finger or a stylus pen.

For example, internal display 23b is a LCD (Liquid Crystal Display) or an organic EL (Electroluminescence), and displays, for example, predetermined data (for example, numeric keys) for inputting the authentication information (for example, the PIN or signature) of the customer in the settlement application. Data displayed on internal display 23b is not limited to the numeric keys.

Power-supply 24 is a power supply of secured area SA, receives power from battery 25, and supplies power to secured area SA (for example, first CPU 21a). First CPU 21a can supply the power and stop the supply of the power to a part or all of the circuits arranged in secured area SA by controlling power-supply 24.

In non-secured area TA, second CPU 31, second flash ROM 32, second RAM 33, second touch-input detector 34a, internal display 34b as an example of a display unit, second I/F 36, power-supply 37, battery 38, out-camera 39, local area radio communicator 40 to which local area radio antenna 40a is connected, wide area radio communicator 41 to which wide area radio antenna 41a is connected, key-input unit 42, magnetic card reader 43a, contact IC card reader 43b, non-contact IC card reader/writer 43c to which loop antenna LA1 is connected, accelerometer 45, and docking device I/F 46 are provided. Second touch-input detector 34a and internal display 34b constitute touch panel TP2.

In non-secured area TA, various components are electrically and logically connected to second CPU 31. Second CPU 31 manages all the components in non-secured area TA. For example, second CPU 31 performs various controls, processes, settings, determinations and instructions by executing programs stored in second flash ROM 32. Second CPU 31 as an example of an application controller starts and executes various applications stored in second flash ROM 32, and pauses or ends the execution in response to the operation of the salesperson.

Second flash ROM 32 stores various data items and programs. The stored data and program are a program and data used in the settlement application and the business application (for example, a merchandise registration application, a stock management application, a document creation application used on a daily basis, and a spread sheet application), and may be a program for controlling transaction equipment 100 (for example, non-secured area TA). Accordingly, second flash ROM 32 is an example of a storage medium that stores programs and data for information processing in second CPU 31.

For example, when processes associated with the operations of transaction equipment 100 (for example, the components in non-secured area TA) are performed, second RAM 33 is a work memory used to temporarily store processing data generated during the process.

Second touch-input detector 34a detects the touch input of the salesperson or the customer on touch panel TP2. For example, second touch-input detector 34a detects the input on the operation screen of at least one of the settlement application and the business application (for example, the merchandise registration application) displayed on touch panel TP2.

Internal display 34b is, for example, a LCD (Liquid Crystal Display) or an organic EL (Electroluminescence), and displays data regarding the operation screen for inputting various information items (for example, a card brand, a card number, an expiration date, an amount of money, a payment method, and the number of payments) related to the settlement process using the card in, for example, the settlement application, or displays data regarding the operation screen for inputting the quantities or items of merchandises as a sales target in the merchandise registration application. The size of the display area of internal display 34b is less than the size of the display area of external display 500. In other words, even though the operation screens of the same application are considered, the operation screen displayed on external display 500 is larger than the operation screen displayed on internal display 34b, and thus, the salesperson or the customer can easily see the screens.

Second I/F 36 is provided to electrically connect non-secured area TA to secured area SA, and delivers various data items and commands between non-secured area TA and secured area SA through first I/F 22. First I/F 22 and second I/F 36 can be coupled to each other.

Power-supply 37 is a power supply of non-secured area TA, and receives power from battery 38, and supplies power to non-secured area TA (for example, second CPU 31). Second CPU 31 can supply the power and stop the supply of the power to a part or all of the circuits arranged in non-secured area TA by controlling power-supply 37.

Out-camera 39 is a camera provided such that a lens is exposed from the housing of transaction equipment 100, and obtains image data by capturing an image of light in a range in which the light is incident on the lens in response to the operation on key-input unit 42 or touch panel TP2, for example.

Local area radio communicator 40 is connected to local area radio antenna 40a, and performs communication using, for example, a wireless LAN by using local area radio communication path. Local area radio communicator 40 may perform communication (for example, communication using Bluetooth (registered trademark)) other than wireless LAN communication.

Wide area radio communicator 41 is connected to wide area radio antenna 41a, and performs communication using a wide area radio communication path (for example, a WAN (Wide Area Network)). The communication in the wide area radio communication path may be performed using, for example, a radio telephone network (a cellular network (W-CDMA (Wideband Code Division Multiple Access), CDMA (Code Division Multiple Access) 2000, or LTE (Long Term Evolution)).

For example, in a case where various buttons are provided on the housing of transaction equipment 100, key-input unit 42 receives push operations of various buttons. In a case where various buttons are not provided on the housing of transaction equipment 100, key-input unit 42 may be omitted from the configuration of transaction equipment 100.

Magnetic card reader 43a is provided on a side surface of the housing of transaction equipment 100 close to non-secured area TA in the transverse direction (see FIG. 3), is provided with a slit which is formed in the side surface and through which a swipe operation is performed in a state in which the salesperson holds the magnetic card, and reads a magnetic stripe of the magnetic card in response to the swipe operation. Information regarding the magnetic stripe read by magnetic card reader 43a is input to second CPU 31. Magnetic card reader 43a may be provided in secured area SA.

Contact IC card reader 43b is disposed within an insertion hole of the contact IC card which is formed in the side surface of the housing of transaction equipment 100 close to secured area SA in the transverse direction (see FIG. 3), and reads card information registered in a chip within the contact IC card through an electrode of the contact IC card (for example, an IC credit card) inserted into the insertion hole. The card information read by contact IC card reader 43b is input to second CPU 31. Contact IC card reader 43b may be provided within secured area SA.

Non-contact IC card reader 43c is connected to loop antenna LA1 disposed in a portion of the housing of transaction equipment 100 close to non-secured area TA (that is, a portion which is substantially parallel to touch panel TP2), performs radio communication with the card (for example, the IC credit card) in a non-contact manner using NFC (Near Field Communication), and reads or writes the card information registered in the card. The card information read by non-contact IC card reader/writer 43c is input to second CPU 31. Non-contact IC card reader/writer 43c may regularly authenticate with respect to non-contact reader/writer 71 of docking device 200 whether or not the transaction equipment is electrically connected to docking device 200 through communication between loop antenna LA1 of transaction equipment 100 and loop antenna LA2 of docking device 200. Non-contact IC card reader/writer 43c to which loop antenna LA1 is connected may be provided within secured area SA.

Accelerometer 45 detects accelerations in an X-axis direction, a Y-axis direction and a Z-axis direction (see three-axis direction shown in FIG. 3) of transaction equipment 100, and outputs the detection result to second CPU 31. Accelerometer 45 can detect a gravity direction (a vertically downward direction, that is, a −Z-axis direction) of transaction equipment 100.

Docking device I/F 46 as an example of an authentication controller performs a regular inquiry (for example, a challenge response process to be described below) about the determination of whether or not transaction equipment 100 and docking device 200 are electrically connected with respect to device authentication controller 63 (to be described below) of docking device 200 through a connector.

As described above, transaction equipment 100 includes secured area SA and non-secured area TA. A “secured” portion requiring “tamper resistance” in transaction equipment 100 during the execution of various applications is localized to secured area SA. Meanwhile, many information processing devices (for example, smartphones or tablet terminals) distributed as devices for consumers or some devices thereof are used in non-secured area TA, as a general-purpose platform.

By using the general-purpose platform in non-secured area TA, development resources of the settlement application and the business application are easily reduced or applied. The settlement application and the business application are flexibly operated without stress by being processed by second CPU 31 of non-secured area TA having, for example, high arithmetic processing ability. Since various settlement application or business applications in which settlement schemes are diversified can be easily used, these applications can be installed in transaction equipment 100.

### Configuration of Docking Device

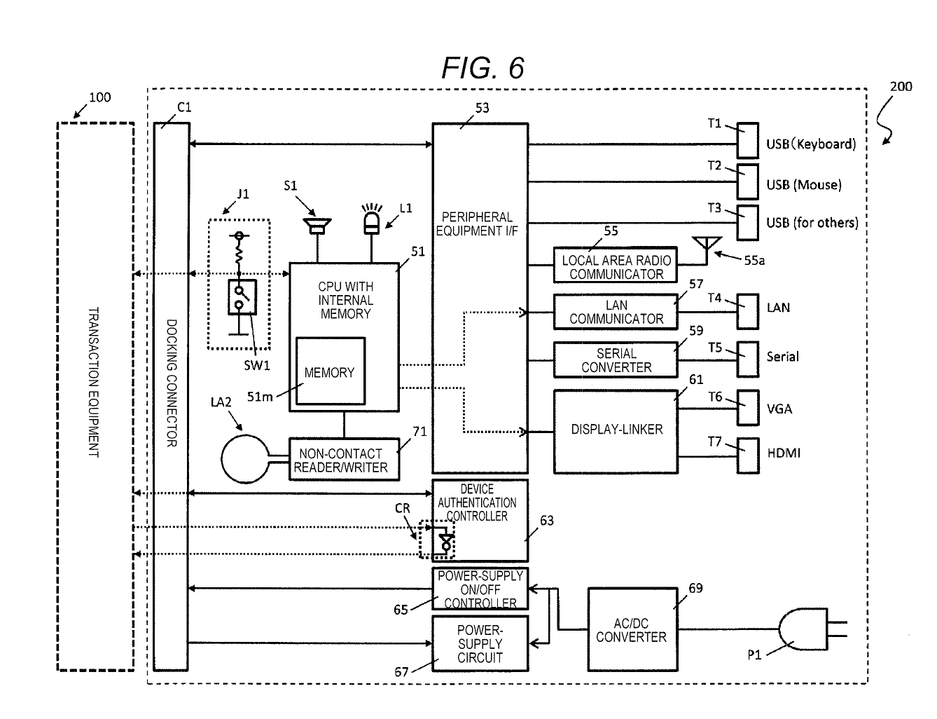

Hereinafter, the hardware configuration of docking device 200 of the present exemplary embodiment will be described with reference to FIG. 6. FIG. 6 is a diagram showing an example of the hardware configuration of docking device 200 of the present exemplary embodiment. In FIG. 6, transaction equipment 100 is also illustrated in order to conveniently describe the operation of docking device 200. Docking device 200 shown in FIG. 6 includes CPU 51 with internal memory, peripheral equipment I/F 53, local area radio communicator 55 to which local area radio antenna 55a is connected, LAN communicator 57, serial converter 59, display-linker 61, device authentication controller 63, power-supply on/off controller 65, power-supply circuit 67, AC/DC converter 69 to which power plug P1 is connected, non-contact reader/writer 71 to which loop antenna LA2 is connected, lock determination part J1, docking connector C1, speaker S1, and LED (Light Emitting Diode) lamp L1.

CPU 51 with internal memory includes memory 51m, and manages all the components in docking device 200. For example, CPU 51 with internal memory performs various controls, processes, settings, determinations, authentications, checks, inquiries and instructions by executing programs stored in memory 51m.

Memory 51m stores various programs and data required for the operation of docking device 200, and functions as a work memory which temporarily stores processing data generated during the operation of CPU 51 with internal memory.

Peripheral equipment I/F 53 delivers data with respect to various peripheral equipments (see FIG. 1) connected to various terminals (terminals T1, T2, T3, T4, T5, T6 and T7) in a direct manner or in an indirect manner through LAN communicator 57, serial converter 59 and display-linker 61. Terminals T1, T2 and T3 are directly connected to peripheral equipment I/F 53. Keyboard 700 is connected to terminal T1. Mouse 750 is connected to terminal T2. Other peripheral equipments (for example, PINPAD 600, sign pad 650, and barcode reader 800) are connected to terminal T3.

Local area radio communicator 55 is connected to local area radio antenna 55a, and performs communication using, for example, a wireless LAN by using a local area radio communication path. Local area radio communicator 55 may perform communication (for example, communication using Bluetooth (registered trademark)) other than wireless LAN communication.

LAN communicator 57 is connected to terminal T4, is connected to a local network (for example, an intranet of the store) through terminal T4, and performs transmission and reception of data with the network. For example, the intranet of the store is connected to terminal T4.

Serial converter 59 is connected to terminal T5, performs serial-to-parallel conversion of data, and performs the transmission of print data of the predetermined receipts (for example, the customer receipt and the store receipt) transmitted from transaction equipment 100 or the reception of a print completion notification of the print data transmitted from receipt printer 300 with respect to receipt printer 300 connected to terminal T5. Serial converter 59 transmits a control signal for pushing cash drawer 400 in the opening direction to cash drawer 400 through receipt printer 300. Receipt printer 300 is connected to terminal T5.

Display-linker 61 is connected to terminals T6 and T7, and delivers data regarding at least one operation screen of the settlement application and the business application transmitted from transaction equipment 100 to external display 500 or customer display 550 connected to terminals T6 and T7. External display 500 or customer display 550 capable of handling data corresponding to VGA (Video Graphical Array) is connected to terminal T6. External display 500 or customer display 550 capable of handling data corresponding to HDMI (High-Definition Multimedia Interface) (registered trademark) is connected to terminal T7.

For example, device authentication controller 63 includes challenge response controller CR, and regularly performs a challenge response process as an authentication method for authenticating whether or not transaction equipment 100 and docking device 200 are correctly connected. In the challenge response process, challenge data is sequentially delivered to challenge response controller CR, docking connector C1, the connector of transaction equipment 100, docking device I/F 46, and second CPU 31, and response data is sequentially delivered to second CPU 31, docking device I/F 46, the connector of transaction equipment 100, docking connector C1, and challenge response controller CR. In a case where correct response data is obtained as the processing result of challenge response controller CR, device authentication controller 63 determines that correct transaction equipment 100 is attached to and is connected to docking device 200.

Power-supply on/off controller 65 receives a part of a DC power obtained by converting (for example, rectification and smoothing) a commercial power supply (power) supplied to power plug P1 in AC/DC converter 69 and determines whether or not to supply the DC power to transaction equipment 100 through docking connector C1. The commercial power supply is constantly supplied to docking device 200 through power plug P1. However, since only batteries 25 and 38 are provided in transaction equipment 100, in a case where it is determined that the remaining capacity of batteries 25 and 38 of transaction equipment 100 is less than a predetermined value, power-supply on/off controller 65 can supply the power to transaction equipment 100. In other words, if the transaction equipment is attached to and is connected to docking device 200, transaction equipment 100 can charge batteries 25 and 38.

Power-supply circuit 67 supplies power supplies (powers) that are suitable for various components for operating the various components of docking device 200 by using a part of the DC power obtained by performing conversion (for example, rectification and smoothing) in AC/DC converter 69.

Non-contact reader/writer 71 is connected to loop antenna LA2, and regularly authenticates whether or not the docking device is electrically connected to transaction equipment 100 with respect to non-contact IC card reader/writer 43c of transaction equipment 100 through communication between loop antenna LA2 and loop antenna LA1 of transaction equipment 100.

Locking determination part J1 includes switch SW1, and determines whether or not transaction equipment 100 is physically attached to and is fixed to docking device 200. Specifically, in a case where the housing of transaction equipment 100 is held in and is attached to equipment holder ECP of docking device 200 and locking part J2 is fixed through a tool such as a driver, switch SW1 is turned on, and thus, locking determination part J1 determines that transaction equipment 100 is physically attached to and is fixed to docking device 200. Meanwhile, in a case where the housing of transaction equipment 100 is not held in equipment holding space ECPV of docking device 200, or in a case where the housing of the transaction equipment is held in and is attached to equipment holding space and locking part J2 is not fixed through the tool such as the driver, switch SW1 is turned off, and thus, locking determination part J1 determines that transaction equipment 100 is not physically fixed to docking device 200. Although it has been described that the ON and OFF of switch SW1 and the attachment and detachment of transaction equipment 100 to and from docking device 200 correspond to each other, and vice versa. In other words, in a case where switch SW1 is turned off, transaction equipment 100 may be physically fixed to docking device 200, and in a case where switch SW1 is turned on, transaction equipment 100 may not be physically fixed to docking device 200.

In a case where the housing of transaction equipment 100 is held in and is attached to equipment holder ECP of docking device 200, docking connector C1 electrically connects transaction equipment 100 and docking device 200.

In a case where a predetermined condition is satisfied, speaker S1 outputs an alert sound having a predetermined volume in response to an instruction of CPU 51 with internal memory.

LED lamp L1 can emit light of a LED, and emits light of predetermined color (for example, blue) in response to an instruction of CPU 51 with internal memory in a case where a predetermined condition is satisfied.

### Example of Operation Screen of Settlement Application

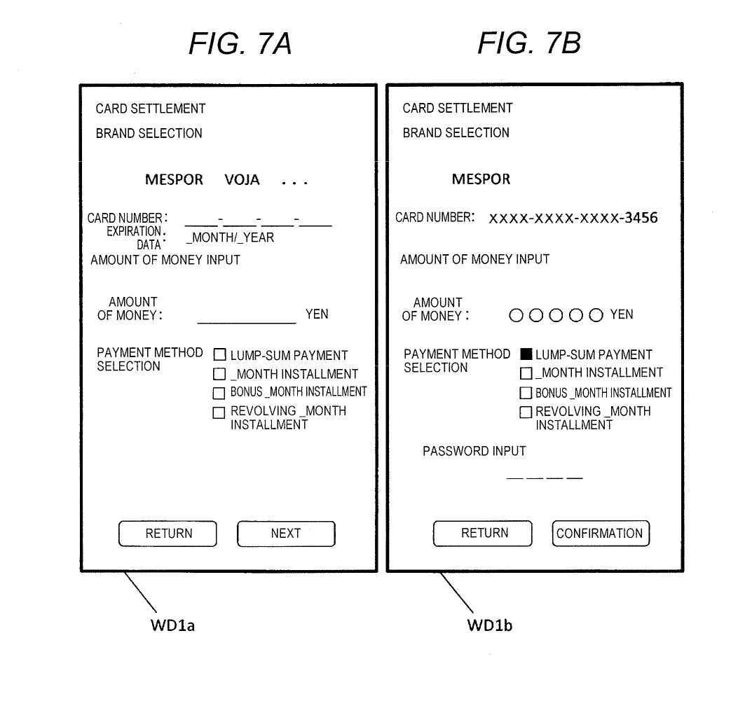

Hereinafter, the operation screen of the settlement application (for example, a card settlement application) installed in transaction equipment 100 will be described with reference to FIGS. 7A and 7B. FIG. 7A is a diagram showing a first example in which operation screen WD1a of the card settlement application executable in transaction equipment 100 is displayed on touch panel TP2 of transaction equipment 100. FIG. 7B is a diagram showing a second example in which operation screen WD1b of the card settlement application executable in transaction equipment 100 is displayed on touch panel TP2 of transaction equipment 100.

On operation screen WD1a shown in FIG. 7A, a card brand of a card used in the settlement of the commercial transaction is displayed such that the salesperson can select the card brand from “MESPOR”, “VOJA”, . . . , and a card number, an expiration date of the card, a settlement amount of money of the commercial transaction, a payment method as a settlement method of the card, and the number of payments are displayed. If the number of payments is input, an item “next” is input through the touch, and an input screen of settlement information (for example, a PIN as authentication information) which is subsequently input is displayed.

On operation screen WD1b shown in FIG. 7B, an input area for inputting the authentication information (for example, the PIN) for authenticating the customer as a legitimate owner of the card in addition to screen operation WD1a shown in FIG. 7A. On the operation screen shown in FIG. 7B, a card brand “MESPOR” is already selected, a card number “xxxx-xxxx-xxxx-3456” and an expiration data thereof (is not displayed after the card number and the expiration data are input) are input, and the payment amount of money and “lump-sum payment” as the payment method are input.

For example, in a case where the PIN is input as the authentication information for authenticating the customer as the legitimate owner of the card, transaction equipment 100 transmits the authorization inquiry of the settlement process including the card brand, the card number, the expiration data, the amount of money, the payment method, the number of payments, and the PIN to settlement server STLC through in a direct manner or in an indirect manner through docking device 200, in response to the input operation of the salesperson. In settlement server STLC, the determination (that is, the determination of whether or not to authorize the customer as a target of the settlement process) of the authorization inquiry is performed, and the determination result (for example, notification that the authorization is possible) of the authorization inquiry is transmitted to transaction equipment 100 from settlement server STLC in the direct manner or in the indirect manner through docking device 200. If the determination result (for example, notification that the authorization is possible) of the authorization inquiry is received, transaction equipment 100 transmits a process request for sales registration of the amount of money in the settlement process of the commercial transaction to settlement server STLC in the direct manner or the indirect manner through docking device 200. In settlement server STLC, a sales registration process is performed in response to the process request for the sales registration from transaction equipment 100, and the processing result of the sales registration is sent to transaction equipment 100. Thus, transaction equipment 100 can determine that the settlement process related to one commercial transaction is normally ended in the settlement application.

### Example of Operation Screen of Merchandise Registration Application

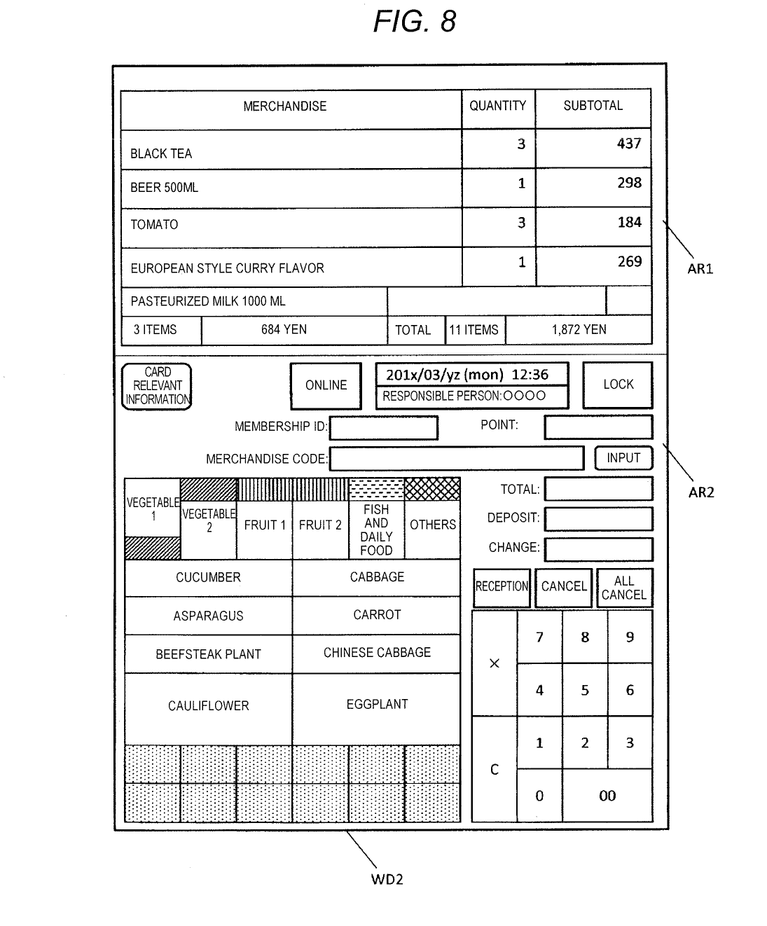

Hereinafter, operation screen WD2 of the merchandise registration application (that is, an application for registering the quantities or items of the services or merchandises as sales targets in a database inside or outside the store) installed in transaction equipment 100 will be described with reference to FIG. 8. FIG. 8 is a diagram showing an example in which operation screen WD2 of the merchandise registration application executable in transaction equipment 100 is displayed on touch panel TP2 of transaction equipment 100.

Operation screen WD2 shown in FIG. 8 includes an item and quantity display area AR2 for inputting the items and quantities of the merchandises or services as sales targets, and a registering target list display area AR1 for displaying the item, quantity and subtotal (that is, the product of the unit price and quantity of merchandises or services) of the merchandises or services input in item and quantity display area AR2 and the total amount of money (that is, the payment amount of money of the customer) related to the settlement (for example, a cash settlement or a card settlement) of the commercial transaction.

Transaction equipment 100 displays operation screen WD2 on internal display 34b shown in FIG. 8 after the merchandise registration application is started. For example, in a case where the customer purchases “three black tea products”, “one can of 500-ml beer”, “three tomatoes”, “one European style curry flavor” and “three cartons of 1000-ml pasteurized milk”, the salesperson sequentially inputs combinations of the items and quantities of the merchandises as sales targets on item and quantity display area AR2 of operation screen WD2 displayed on internal display 34b through the touch. For example, the salesperson may input the items and quantities of all the merchandises by reading barcodes assigned to the merchandises by means of barcode reader 800 even though the salesperson does not perform the touch input. If the input of the items and quantities of all the merchandises is ended, transaction equipment 100 displays the merchandises as sales targets, the quantities of the merchandises, and the payment amount of money on registering target list display area AR1 of operation screen WD2 displayed on internal display 34b. Thus, during the execution of the merchandise registration application, transaction equipment 100 can register the services or merchandises as sales targets, and the quantities and the total amount of money thereof in correlation with a sales date and identification information (for example, the name of the salesperson) regarding the salesperson in response to the operation on operation screen WD2 shown in FIG. 8.

Operation Depending on Attachment or Detachment of Transaction Equipment to or from Docking Device

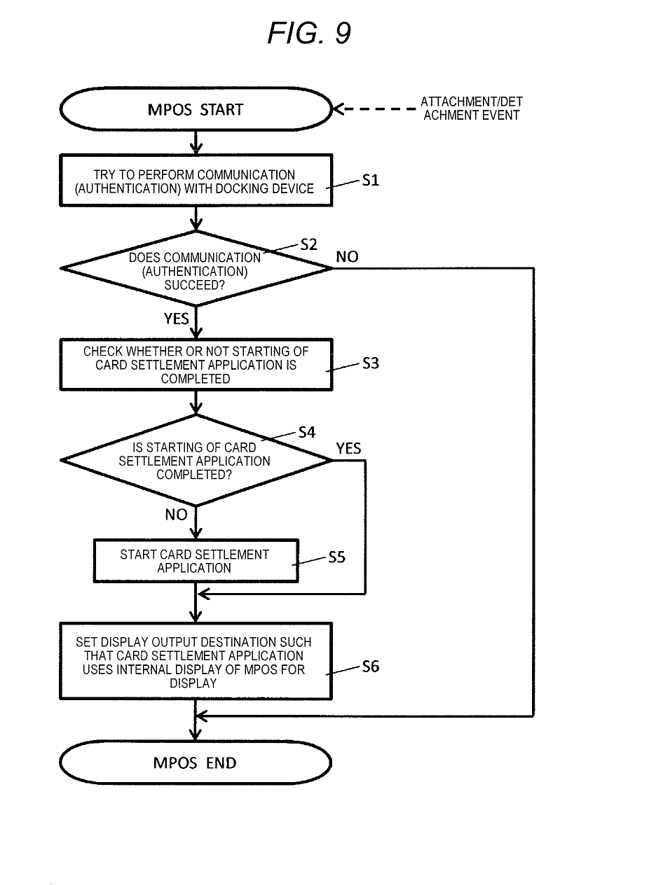

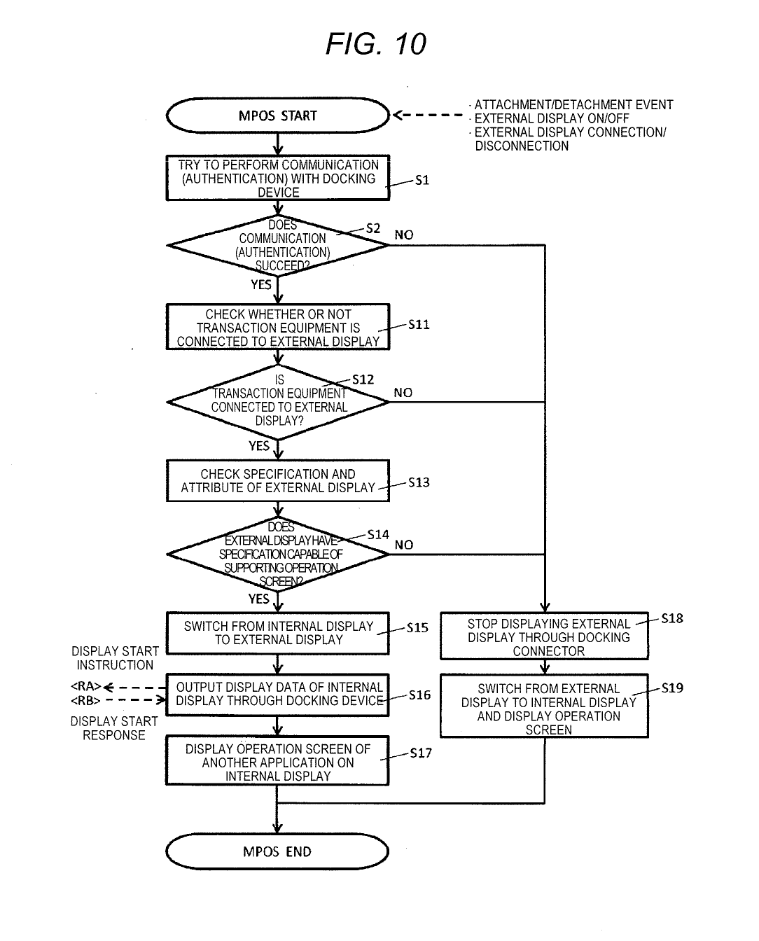

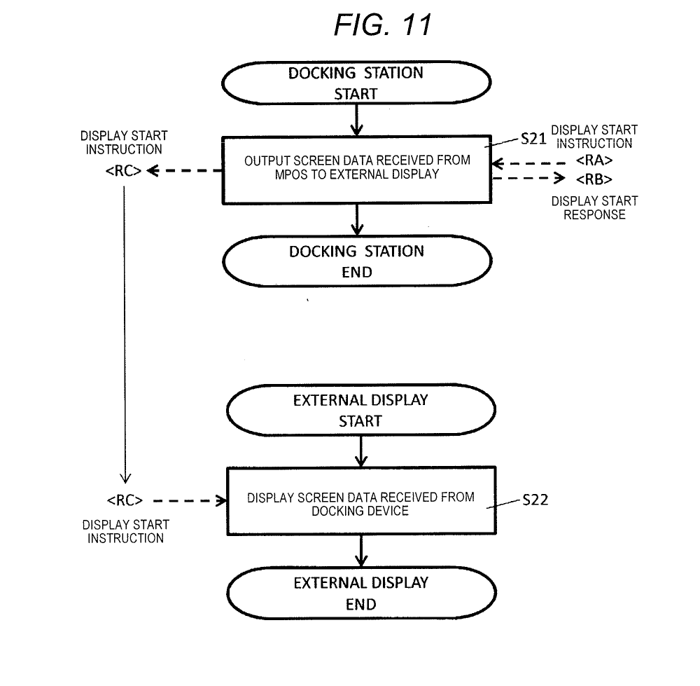

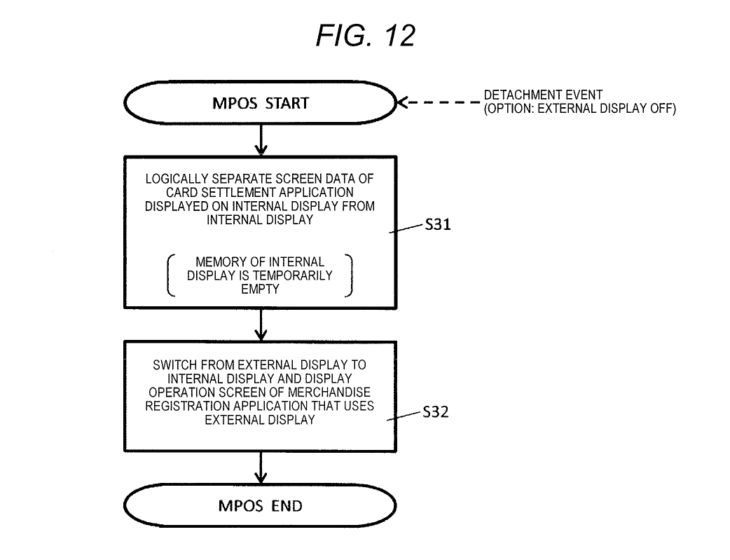

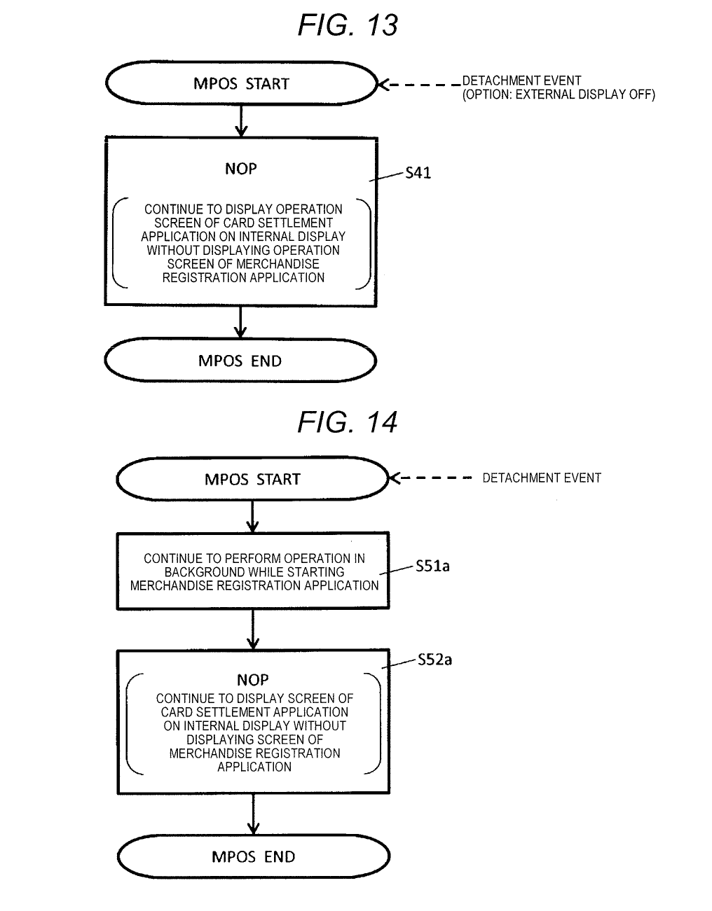

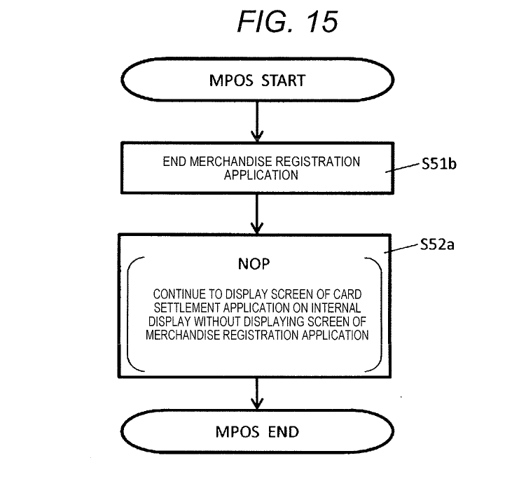

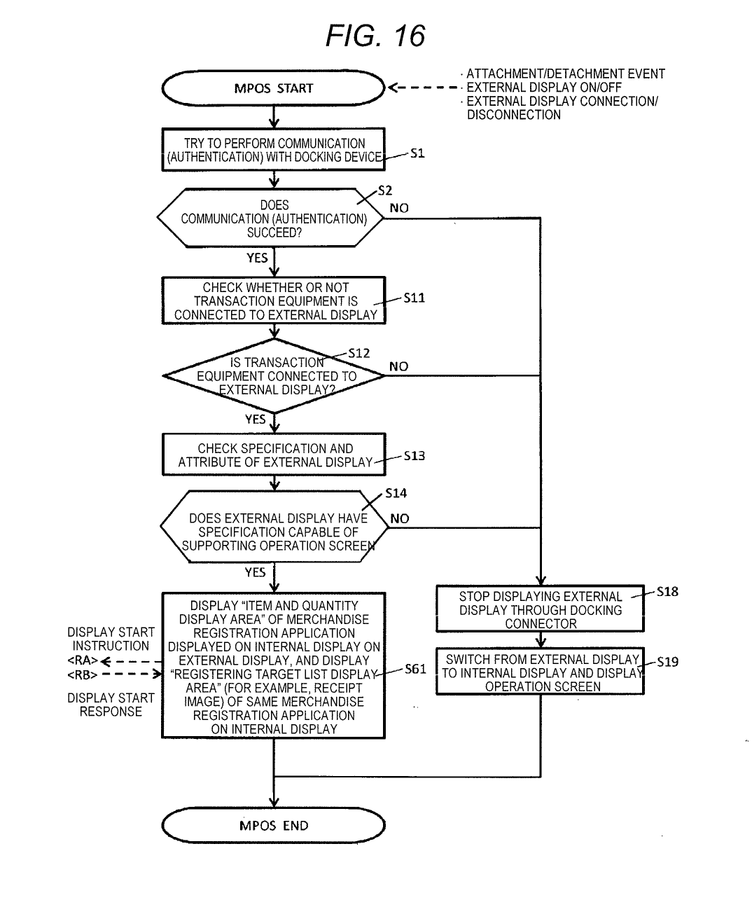

Hereinafter, the operation depending on the attachment or detachment of transaction equipment 100 to or from docking device 200 will be described with reference to FIG. 9 and the subsequent drawings. FIG. 9 is a flowchart for describing a first example of an operation procedure of transaction equipment 100 of the present exemplary embodiment. FIG. 10 is a flowchart for describing a second example of an operation procedure of transaction equipment 100 of the present exemplary embodiment. FIG. 11 is a flowchart for describing a first example of an operation procedure of docking device 200 and external display 500 which receive display data shown in FIG. 10. FIG. 12 is a flowchart for describing a first modification example of an operation procedure of the transaction equipment in a case where the transaction equipment is detached from the docking device. FIG. 13 is a flowchart for describing a second modification example of an operation procedure of the transaction equipment in a case where the transaction equipment is detached from the docking device. FIG. 14 is a flowchart for describing a third modification example of an operation procedure of the transaction equipment in a case where the transaction equipment is detached from the docking device. FIG. 15 is a flowchart for describing a fourth modification example of an operation procedure of the transaction equipment in a case where the transaction equipment is detached from the docking device. FIG. 16 is a flowchart for describing a third example of an operation procedure of the transaction equipment of the present exemplary embodiment.

In the following description, for example, it is assumed that a case where transaction equipment 100 is attached to docking device 200 is a case where transaction equipment 100 is held in and is attached to equipment holding space ECPV of docking device 200, locking part J2 is fixed through a tool such as a driver and is physically fixed, and device authentication controller 63 authenticates that correct transaction equipment 100 is attached to and is electrically connected to docking device 200 as the result of a challenge response process between transaction equipment 100 and docking device 200.

In the following description, it is assumed that a case where transaction equipment 100 is detached from docking device 200 is, for example, a case that satisfies at least one of a case where transaction equipment 100 is detached from equipment holding space ECPV of docking device 200, a case where the physical fixation of transaction equipment 100 to docking device 200 is released as the result in which the locked state of locking part J2 is released, and a case where an abnormality result is obtained in the challenge response process between transaction equipment 100 and docking device 200 and the authentication fails.

In FIG. 9, in a case where external display 500 is not connected to docking device 200, the operation of transaction equipment 100 (MPOS) when transaction equipment 100 is attached to or is detached from docking device 200 is illustrated.

In FIG. 9, second CPU 31 of transaction equipment 100 tries to perform communication (authentication) of the challenge response process with respect to docking device 200 through docking device I/F 46 (S1). As described above, in the challenge response process, challenge data is transmitted from docking device 200 with docking device 200 as its origin. In a case where docking device I/F 46 receives the challenge data, second CPU 31 calculates response data corresponding to the challenge data, and transmits the response data to docking device 200 through docking device I/F 46.

As the result of the challenge response process in step S1, in a case where it is not authenticated that correct transaction equipment 100 is attached to and is electrically connected to docking device 200 (S2, NO), the process of transaction equipment 100 shown in FIG. 9 is ended.

For example, as the result of the challenge response process in step S1, in a case where it is authenticated that correct transaction equipment 100 is attached to and is electrically connected to docking device 200 (S2, YES), second CPU 31 checks whether or not the starting of a settlement application (referred to as a “card settlement application”) using a card is completed (S3). In a case where it is checked that the starting of the card settlement application is completed (S4, YES), the process of transaction equipment 100 proceeds to step S6. Meanwhile, in a case where it is checked that the starting of the card settlement application is not completed (S4, NO), second CPU 31 starts the card settlement application (S5).

In the description of FIG. 9, since external display 500 is not connected to docking device 200, second CPU 31 determines that internal display 34b of transaction equipment 100 is used as a display output destination of an operation screen (see, for example, operation screen WD1a shown in FIG. 7A) of the card settlement application, and sets the display output destination of internal display 34b (S6). Thus, transaction equipment 100 can display the operation screen of the card settlement application on internal display 34b.

In FIG. 10, in a case where external display 500 is connected to docking device 200, the operation of transaction equipment 100 (MPOS) when transaction equipment 100 is attached to or is detached from docking device 200, when the power-supply of external display 500 is turned on or off, or when external display 500 is connected to or is disconnected from docking device 200 is illustrated.

In FIG. 10, as the result of the challenge response process in step S1, in a case where it is not authenticated that correct transaction equipment 100 is attached to and is electrically connected to docking device 200 (S2, NO), second CPU 31 of transaction equipment 100 stops displaying the operation screen of the application displayed on external display 500 through docking connector C1 (S18). Second CPU 31 switches from the external display to internal display 34b, and displays the operation screen of the application displayed on external display 500 (S19).

Meanwhile, as the result of the challenge response process in step S1, in a case where it is authenticated that correct transaction equipment 100 is attached to and is electrically connected to docking device 200 (S2, YES), second CPU 31 checks whether or not the transaction equipment is connected to external display 500 through docking device 200 (S11). In a case where it is checked that external display 500 is not connected to the transaction equipment (S12, NO), the process of transaction equipment 100 proceeds to step S18.

Meanwhile, in a case where it is checked that external display 500 is connected to the transaction equipment (S12, YES), second CPU 31 obtains information regarding the specification and attribute of external display 500, and checks whether or not external display 500 has the specification capable of displaying (supporting) the operation screen of the application installed in transaction equipment 100 (S13). In a case where it is checked that external display 500 does not have the specification capable of displaying (supporting) the operation screen of the application installed in transaction equipment 100 (S14, NO), the process of transaction equipment 100 proceeds to step S18.

Meanwhile, in a case where it is checked that external display 500 has the specification capable of displaying (supporting) the operation screen of the application installed in transaction equipment 100 (S14, YES), second CPU 31 determines that the display output destination of the operation screen of the application is switched to external display 500 from internal display 34b (S15). Second CPU 31 transmits display starting instruction RA including display data of the operation screen of the application to docking device 200 through docking connector C1 (S16). Second CPU 31 receives a display starting response RB indicating that the display data of the operation screen of the application is instructed to be displayed on external display 500 from docking device 200 through docking connector C1.

After step S16, second CPU 31 displays an operation screen of another application on internal display 34b (S17). In a case where a plurality of application is started, the another application may be another application other than the application of which the operation screen is displayed on external display 500 through switching of the display, or may be previously determined in transaction equipment 100. In a case where an application is not previously determined, second CPU 31 may display a list of applications installed in transaction equipment 100 on internal display 34b, and may display an initial screen of an application selected by a salesperson. Thus, for example, transaction equipment 100 switches to external display 500 such that operation screen WD2 of a merchandise registration application is displayed on external display 500 through switching of the display, and easily start an arbitrary application corresponding to the situation of the salesperson by allowing the salesperson to select the application in a case where the salesperson does not determine the operation screen of the application displayed on internal display 34b.

In FIG. 11, docking device 200 outputs display starting instruction RC including the screen data (that is, the display data of the operation screen of the application) received from transaction equipment 100 on external display 500 through display linker 61 according to display starting instruction RA in step S16 (S21). Docking device 200 transmits display starting response RB indicating that the display data of the operation screen of the application is instructed to be displayed on external display 500 to transaction equipment 100 through docking connector C1.

External display 500 displays the screen data (that is, the display data of the operation screen of the application) received from docking device 200 according to display starting instruction RC in step S21 (S22). Thus, for example, since transaction equipment 100 can switch the internal display to the external display and display operation screen WD2 (see FIG. 8) of the merchandise registration application displayed on internal display 34b, on external display 500, it is possible to allow the salesperson or the customer to easily see operation screen WD2 of the merchandise registration application on external display 500 having a display area wider than that of internal display 34b, and it is possible to improve the convenience when an input operation of the salesperson or the customer on operation screen WD2.

In FIG. 12, another operation related to the display of transaction equipment (MPOS) 100 when transaction equipment 100 is detached from docking device 200 is illustrated. The description shown in FIG. 12 may be applied to a case where transaction equipment 100 is detached from docking device 200 and the power-supply of external display 500 is turned off. As the assumption of the description of FIG. 12, it is assumed that the operation screen of the merchandise registration application is displayed on external display 500 and the operation screen of the card settlement application is displayed on internal display 34b of transaction equipment 100.

In FIG. 12, second CPU 31 of transaction equipment 100 stops displaying the operation screen of the card settlement application displayed on internal display 34b on internal display 34b, and logically separates the data (the display data) of the operation screen of the card settlement application from internal display 34b (S31). Thus, a memory of internal display 34b is temporarily empty.

Second CPU 31 switches from the external display to the internal display, and displays the operation screen of the merchandise registration application, which is displayed on external display 500, on internal display 34b (S32). Thus, for example, even in a case where it is necessary to turn off the power-supply of external display 500 as power saving measures, or even in a case where it is necessary for the salesperson to move from the arrangement position of docking device 200, transaction equipment 100 can continuously perform the operation of the salesperson on the operation screen of the merchandise registration application without stopping the merchandise registration application displayed on external display 500 in the middle of the process.

In FIG. 13, another operation related to the display of transaction equipment (MPOS) 100 when transaction equipment 100 is detached from docking device 200 is illustrated. The description shown in FIG. 13 may be applied to a case where transaction equipment 100 is detached from docking device 200 and the power-supply of external display 500 is turned off. As the assumption of the description of FIG. 13, it is assumed that the operation screen of the merchandise registration application is displayed on external display 500 and the operation screen of the card settlement application is displayed on internal display 34b of transaction equipment 100.

In FIG. 13, second CPU 31 of transaction equipment 100 stops displaying the operation screen of the merchandise registration application displayed on external display 500, and continuously displays the operation screen of the card settlement application displayed on internal display 34b on internal display 34b without change (S41). Thus, for example, even in a case where the power-supply of external display 500 is turned off, transaction equipment 100 can continuously perform the operation of the salesperson on the operation screen of the card settlement application without stopping the card settlement application displayed on internal display 34b in the middle of the process.

In FIG. 14, another operation related to a master process of transaction equipment (MPOS) 100 when transaction equipment 100 is detached from docking device 200 is illustrated. The description shown in FIG. 14 may be applied to a case where transaction equipment 100 is detached from docking device 200 and the power-supply of external display 500 is turned off. As the assumption of the description of FIG. 14, it is assumed that the operation screen of the merchandise registration application is displayed on external display 500 and the operation screen of the card settlement application is displayed on internal display 34b of transaction equipment 100.

In FIG. 14, second CPU 31 of transaction equipment 100 continues to perform the operation in the background while starting the merchandise registration application of which the operation screen is displayed on external display 500 (S51a).

Second CPU 31 stops the display of the operation screen of the merchandise registration application on external display 500, and continuously displays the operation screen of the card settlement application on internal display 34b while maintaining an execution state of the card settlement application (S52a).

In FIG. 15, another operation related to a master process of transaction equipment (MPOS) 100 when transaction equipment 100 is detached from docking device 200 is illustrated. The description shown in FIG. 15 may be applied to a case where transaction equipment 100 is detached from docking device 200 and the power-supply of external display 500 is turned off. As the assumption of the description of FIG. 15, it is assumed that the operation screen of the merchandise registration application is displayed on external display 500 and the operation screen of the card settlement application is displayed on internal display 34b of transaction equipment 100.

In FIG. 15, second CPU 31 of transaction equipment 100 ends the merchandise registration application of which the operation screen is displayed on external display 500 (S51b). The operation of transaction equipment 100 subsequent to step S5lb is the same as that of step S52a, and thus, the description thereof will be omitted.

In FIG. 16, another operation of transaction equipment 100 (MPQS) when transaction equipment 100 is attached to docking device 200, when the power-supply of external display 500 is turned on or off, or when external display 500 is connected to or is disconnected from docking device 200 in a case where external display 500 is connected to docking device 200 is illustrated. As the assumption of the description of FIG. 16, the operation screen (see, for example, FIG. 8) of the card settlement application is displayed on internal display 34b of transaction equipment 100.

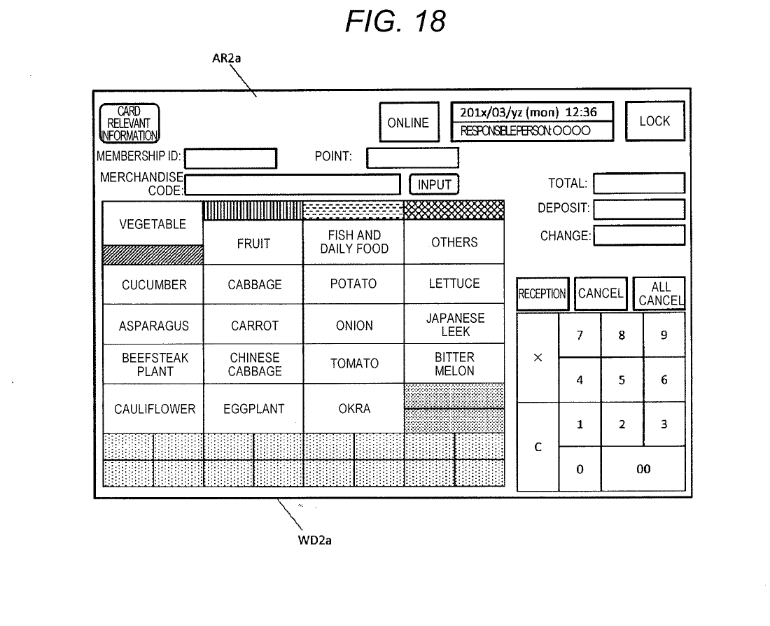

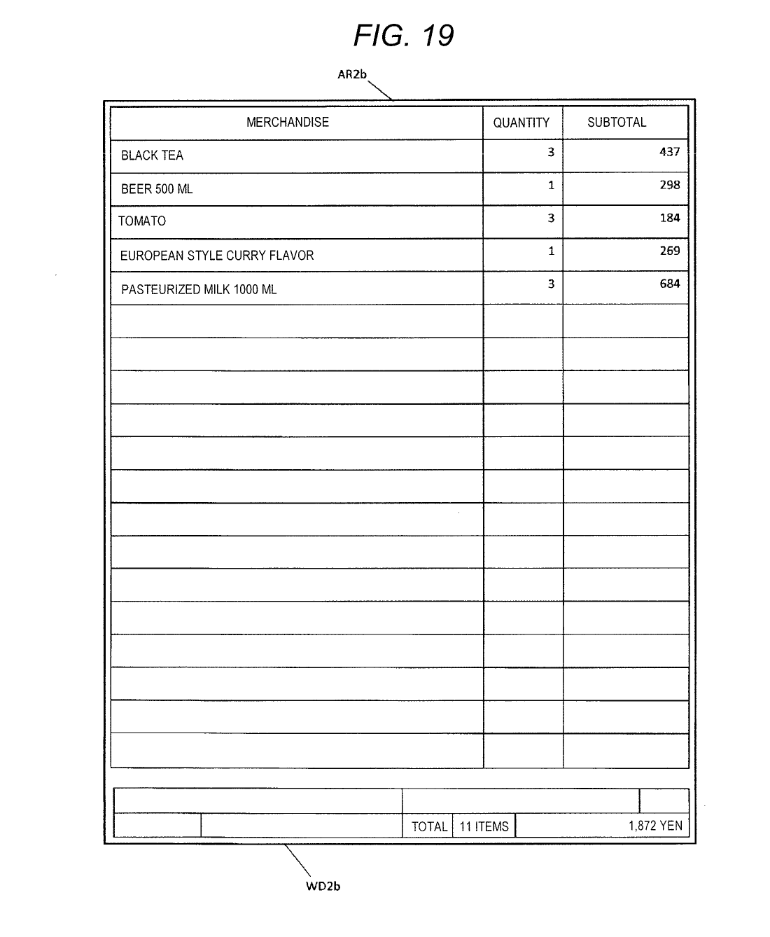

In FIG. 16, in a case where it is checked that external display 500 has the specification capable of displaying (supporting) the operation screen of the application installed in transaction equipment 100 (S14, YES), second CPU 31 displays operation screen WD2a having the same content as that of item and quantity display area AR2 of the merchandise registration application displayed on internal display 34b on external display 500 (S61) (see FIG. 18). Second CPU 31 displays operation screen WD2b having the same content as that of registering target list display area AR1 (for example, receipt image) of the same merchandise registration application on internal display 34b (S61) (see FIG. 19).

FIG. 18 is a diagram showing an example of operation screen WD2a of the merchandise registration application displayed on external display 500. FIG. 19 is a diagram showing an example of operation screen WD2b of the merchandise registration application displayed on internal display 34b of transaction equipment 100. As shown in FIG. 18, on external display 500 having a display area wider than that of internal display 34b, operation screen WD2a including item and quantity display area AR2a which is more detailed and is broader than those of item and quantity display area AR2 shown in FIG. 8 is displayed.

That is, for example, on operation screen WD2 shown in FIG. 8, since the display area of internal display 34b is smaller than the display area of external display 500, items of all the vegetables are not displayed, the vegetable items are classified into a plurality of tabs such as “vegetable 1” and “vegetable 2”, and only the vegetable items belonging to each classification are displayed. Thus, in a case where “asparagus” belonging to “vegetable 1” is selected, there is no inconvenience of performing the input operation of the salesperson. However, it is necessary to perform an operation of switching from “vegetable 1” being currently selected to “vegetable 2” in a case where “onion” belonging to “vegetable 2” is selected, and it is necessary to select “onion” belonging to “vegetable 2” after the switching. If the display area of internal display 34b is small, an erroneous operation of the input operation of the item occurs in the way that the salesperson erroneously selects an incorrect item at the time of performing the touch input of the item. The convenience is decreased in the way that it is necessary to perform the operation such that operation screen WD2 is enlarged.

Incidentally, since the display area of internal display 34b is wider than the display area of external display 500, the items of all the vegetables can be displayed on operation screen WD2a shown in FIG. 18, and the vegetable item belonging to one classification of “vegetable” is displayed. Thus, it is possible to improve visibility of operation screen WD2a of the merchandise registration application of the salesperson, and it is possible to easily select and input the items of the merchandise as sales targets. Since transaction equipment 100 can display operation screen WD2a of the merchandise registration application on external display 500, it is possible to reduce the number of times the salesperson erroneously selects the incorrect item. As a result, it is possible to reduce the erroneous operation at the time of the item selection, and it is possible to prevent the convenience from being decreased.

As shown in FIG. 19, on external display 500 having a display area wider than that of internal display 34b, operation screen WD2b including item and quantity display area AR2b which is more detailed and is broader than registering target list display area AR1 shown in FIG. 8 is displayed.

That is, for example, on operation screen WD2 shown in FIG. 8, since the display area of internal display 34b is smaller than the display area of external display 500, the visibility of the list of the subtotal, quantities and items of the merchandises as sales targets is not good. Specifically, the name, quantity, and subtotal of the items of “black tea”, “500-ml beer”, “tomato”, and “European style curry flavor” as sales targets and the name, quantity and subtotal of the item of “1000-ml pasteurized milk” are not displayed in the same line, the quantities of the merchandises, the sum of the subtotals, the final quantity of the merchandises, and the total amount of money of the subtotals do not match, the sales person feels a sense of uneasiness about a possibility that the salesperson will forget to input “1000-ml pasteurized milk” at a glance.

Incidentally, operation screen WD2a including the content of item and quantity display area AR2 which is a part of operation screen WD2 is displayed on external display 500, and operation screen WD2b including the content of remaining registering target list display area AR1 is displayed on internal display 34b. That is, since the content of item and quantity display area AR2 is not displayed on internal display 34b, the display area of operation screen WD2b including the content of registering target list display area AR1 is wider than the display area of registering target list display area AR1 shown in FIG. 8. Thus, transaction equipment 100 can display the items (specifically, “black tea”, “500-ml beer”, “tomato”, “European style curry flavor”, and “1000-ml pasteurized milk”), quantities, and subtotal of the merchandises as sales targets such that the items, quantities, and subtotal of the merchandise are arranged in the same line on operation screen WD2b shown in FIG. 19. Accordingly, since transaction equipment 100 can display operation screen WD2b configured such that the items, quantities, and subtotal of the merchandises as sales targets are arranged in the same line on internal display 34b, it is possible to reduce the number of times the salesperson feels a sense of uneasiness about forgetting the input operation, and it is possible to improve the convenience at the time of the input operation of the salesperson.

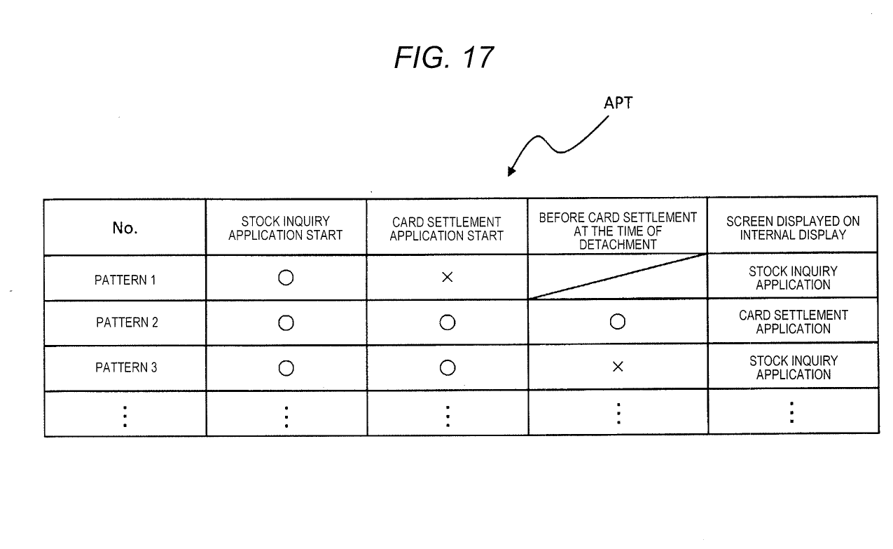

If the transaction equipment is detached from docking device 200, transaction equipment 100 may determine an application to be displayed on internal display 34b based on any one of the classification, operation screen and processing state of the application displayed on external display 500 (see FIG. 17). Transaction equipment 100 displays the operation screen of the determined application on internal display 34b. FIG. 17 is a diagram showing an example of a table that defines the operation screen of the application to be displayed on internal display 34b of transaction equipment 100 in a case where the transaction equipment is detached from docking device 200.

For example, as the assumption of the description of FIG. 17, it is assumed that a stock management application (hereinafter, referred to as a “stock inquiry application” in some cases) is started in transaction equipment 100. For example, in a case where the card settlement application is not started when transaction equipment 100 is detached from docking device 200, transaction equipment 100 continues to display the operation screen of the stock inquiry application on internal display 34b (see Pattern 1 shown in FIG. 17).

For example, in a case where the card settlement application is started when transaction equipment 100 is detached from docking device 200 and the card settlement is not performed yet (that is, the amount of money is not paid), transaction equipment 100 switches from the external display to the internal display, and displays the operation screen of the card settlement application, which is displayed on external display 500, on internal display 34b (see Pattern 2 shown in FIG. 17). Accordingly, for example, in a case where the card settlement is not performed yet in the card settlement application (that is, the amount of money is not paid), transaction equipment 100 displays the operation screen of the card settlement application on internal display 34b without stopping the card settlement application. As a result, it is possible to guarantee the continuity of the process of the card settlement application, and it is possible to improve the convenience at the time of the operation of the salesperson.

For example, in a case where the card settlement application is started when transaction equipment 100 is detached from docking device 200 and the card settlement is already performed (that is, the amount of money is paid), transaction equipment 100 continues to display the operation screen of the stock inquiry application on internal display 34b without displaying the operation screen of the card settlement application displayed on external display 500 on internal display 34b (see Pattern 3 shown in FIG. 17). Accordingly, for example, in a case where the card settlement is already performed in the card settlement application (that is, the amount of money is already paid), since the operation screen of the card settlement application required to be presented to the salesperson or the customer is less displayed, transaction equipment 100 stops the card settlement application, and displays the operation screen of the originally used stock management application on internal display 34b. As a result, it is possible to guarantee the continuity of the process of the stock inquiry application, and it is possible to improve the convenience at the time of the operation of the salesperson.

As stated above, in transaction processing system 1000 of the present exemplary embodiment, transaction equipment 100 can execute at least one of the settlement application and the business application (for example, the merchandise registration application and the stock management application) by using internal display 34b. Docking device 200 is connected to at least one peripheral equipment used in the settlement application or the business application, and can be attached to or detached from transaction equipment 100. For example, in a case where the peripheral equipment is external display 500 having a display area wider than that of internal display 34b, transaction equipment 100 switches from the internal display to the external display, and displays the operation screen of the settlement application or the business application, which is displayed on internal display 34b, on external display 500 through docking device 200 by attaching the transaction equipment to docking device 200.

Accordingly, in transaction processing system 1000, in a case where portable transaction equipment 100 and the peripheral equipment (for example, external display 500) used to execute at least one procedure of the merchandise registration application and the settlement application are used in cooperation with each other, since transaction equipment 100 can display the operation screen, which is wider than at least one operation screen of the merchandise registration application and the settlement application in a case where transaction equipment is used alone, on external display 500 with a simple operation without requiring a complicated setting operation of the salesperson as the user, it is possible to improve the convenience at the time of the operation of the salesperson.

Transaction equipment 100 further displays an operation screen of another application other than the application displayed on external display 500 on internal display 34b. Accordingly, for example, transaction equipment 100 can display an operation screen of an application (for example, the merchandise registration application) having a wide display area on external display 500 with a simple operation such as the attachment of transaction equipment 100 to docking device 200, and can also display an operation screen of another application (for example, an application having no wide display area) on internal display 34b having a display area smaller than that of external display 500. As a result, it is possible to distinguishably use the displays that display the operation screen for each application, and it is possible to improve the convenience at the time of the operation of the salesperson.

A part of the operation screen of the settlement application or the business application is displayed on external display 500, and transaction equipment 100 displays the remaining operation screen of the settlement application or the business application on internal display 34b. Accordingly, for example, transaction equipment 100 can display a part of the operation screen of the application (for example, the merchandise registration application) having a wide display area on external display 500 with a simple operation such as the attachment of transaction equipment 100 to docking device 200 by the salesperson, and can display the remaining operation screen on internal display 34b of transaction equipment 100 present in front of the salesperson. As a result, it is possible to improve macroscopic visibility by easily browsing the entire operation screen of the application, and it is possible to improve the convenience at the time of the operation of the salesperson.

In a case where transaction equipment 100 is detached from docking device 200, the transaction equipment 100 displays the operation screen of the settlement application or the business application displayed on external display 500 on internal display 34b. Thus, for example, in a case where it is not necessary to use the wide display area of external display 500, transaction equipment 100 can easily grasp the entire operation screen of the continuously used application by browsing only internal display 34b with a simple operation such as the detachment of transaction equipment 100 from docking device 200 by the salesperson, and it is possible to improve the convenience at the time of the operation of the salesperson.

In a case where transaction equipment 100 is detached from docking device 200, the transaction equipment continues to display an operation screen of another application displayed on internal display 34b. Accordingly, for example, in a case where it is not necessary to use the application of the operation screen displayed on external display 500, transaction equipment 100 can end the operation of the salesperson on the operation screen of the settlement application or the business application displayed on external display 500 with a simple operation such as the detachment of transaction equipment 100 from docking device 200 by the salesperson, and does not obstruct the displaying of the operation screen of the application displayed on internal display 34b. As a result, it is possible to improve the convenience at the time of the operation of the salesperson.

In a case where transaction equipment 100 is detached from docking device 200, the transaction equipment determines an application to be displayed on internal display 34b based on any one of the classification, operation screen and processing state of the settlement application and the business application displayed on external display 500, and displays the operation screen of the determined application on internal display 34b. For example, in the settlement application using the card (for example, the IC credit card), if the operation screen is switched to another application during the communication between transaction equipment 100 and the settlement center device, the salesperson does not check whether or not the settlement process is normally ended, and feels a sense of uneasiness. Accordingly, transaction equipment 100 can flexibly determine an application capable of being comfortably or continuously used by the salesperson without obstructing the operation of the salesperson on the operation screen depending on the situation (for example, any one of the classification, operation screen, and processing state, or a plurality of combinations thereof) of the application displayed on internal display 34b when the transaction equipment is detached from docking device 200.

For example, internal display 34b may display the operation screen of the settlement application before transaction equipment 100 is attached to docking device 200, and may display the operation screen of the settlement application on external display 500 if transaction equipment 100 is attached to docking device 200. Accordingly, when settlement information (for example, a card brand, a card number, an expiration date, the amount of money, a payment method, the number of payments, and PIN) is input by the salesperson or the customer in the settlement application, since the operation screen is displayed on external display 500 having a display area wider than that of internal display 34b, it is possible to improve the convenience at the time of the input of the salesperson or the customer.

For example, internal display 34b may display the operation screen of the merchandise registration application before transaction equipment 100 is attached to docking device 200, and may display the operation screen of the merchandise registration application on external display 500 if transaction equipment 100 is attached to docking device 200. Accordingly, when merchandise registration information (for example, the item, quantity and amount of money of the merchandise) input by the salesperson in the merchandise registration application is input, since the operation screen having a display area wider than that of internal display 34b is displayed on external display 500, it is possible to improve the convenience at the time of the input of the salesperson.

Transaction equipment 100 can display at least one operation screen of the settlement application and the business application on internal display 34b, and performs the communication connection and authentication with respect to docking device 200 connected to at least one peripheral equipment used in the settlement application or the business application. Here, for example, the peripheral equipment is external display 500 having a display area wider than that of internal display 34b. In a case where the communication with docking device 200 and the attachment of the transaction equipment to docking device 200 is authenticated, transaction equipment 100 switches from the internal display to the external display, and displays the operation screen of the settlement application or the business application, which his displayed on internal display 34b, on external display 500 through docking device 200.

Accordingly, in a case where transaction equipment 100 and the peripheral equipment (for example, external display 500) used in at least one procedure of the merchandise registration application and the settlement application are used in cooperation with each other, transaction equipment 100 displays an operation screen, which is wider than at least one operation screen of the merchandise registration application and the settlement application in a case where transaction equipment 100 is used alone, on external display 500 with a simple operation without requiring a complicated setting operation of the salesperson. As a result, it is possible to improve the convenience at the time of the operation of the user.

### Second Exemplary Embodiment

### Description of Operation Depending on Attachment of Transaction Equipment to Docking Device

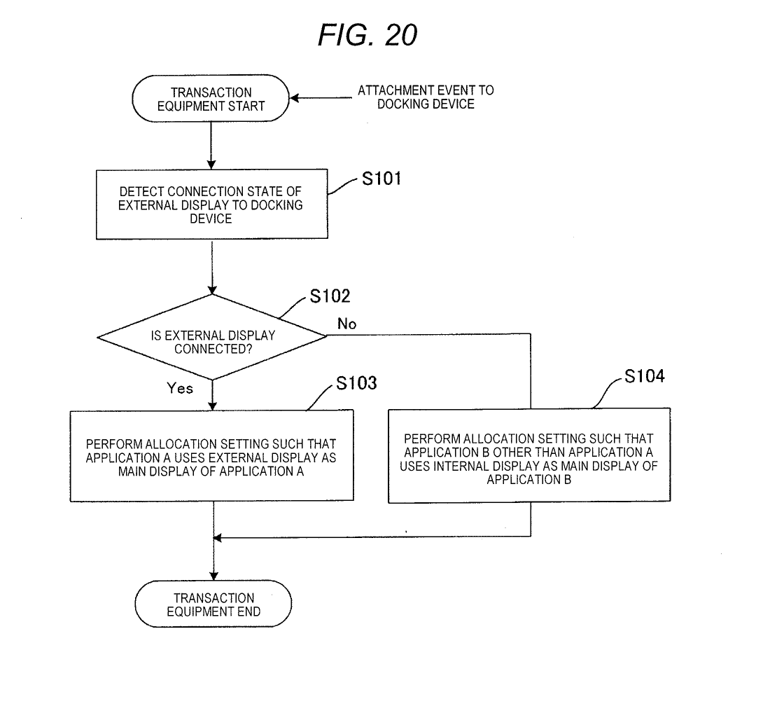

In a second exemplary embodiment, the operation depending on the attachment of transaction equipment 100 to docking device 200 will be described with reference to FIG. 20 and the subsequent drawings. The same configurations and operations as the configurations and operations described in the above-described first exemplary embodiment will be assigned the same reference numerals, and the description thereof will be omitted or simplified. FIG. 20 is a flowchart for describing a first example of an operation procedure of transaction equipment 100 of the present exemplary embodiment.

In the following description, for example, it is assumed that a case where transaction equipment 100 is attached to docking device 200 is a case where transaction equipment 100 is attached by being held in equipment holding space ECPV of docking device 200, locking part J2 is fixed through a tool such as a driver and is physically fixed, and device authentication controller 63 authenticates that correct transaction equipment 100 is attached to and is electrically connected to docking device 200 as the result of the challenge response process between transaction equipment 100 and docking device 200.

In the following description, for example, it is assumed that a case where transaction equipment 100 is detached from docking device 200 is a case that satisfies at least one of a case where transaction equipment 100 is detached from equipment holding space ECPV of docking device 200, a case where the physical fixation of transaction equipment 100 to docking device 200 is released as the result in which the locked state of locking part J2 is released, and a case where an abnormality result in the challenge response process between transaction equipment 100 and docking device 200 is obtained and the authentication fails.

In FIG. 20, the operation of transaction equipment 100 when transaction equipment 100 is attached to docking device 200 is illustrated.

In a case where the attachment event of the transaction equipment to decking device 200 occurs, Second CPU 31 of transaction equipment 100 starts the process of FIG. 20 based on the software interrupt. As stated above, the attachment event of the transaction equipment to docking device 200 occurs in a case where the attachment of transaction equipment 100 to equipment holding space ECPV, the locking due to the fixation of locking part J2, or the attachment authentication of transaction equipment 100 by device authentication controller 63 is performed. Second CPU 31 detects the attachment event by receiving attachment information from docking device 200 through docking device I/F 46.

In FIG. 20, second CPU 31 detects a connection state of external display 500 as the peripheral equipment connected to docking device 200 (step S101). Here, in order to detect the connection state with each peripheral equipment such as external display 500, connection information indicating whether or not the connection with each peripheral equipment is performed is stored and is retained in memory 51m of docking device 200 or second flash ROM 32 of transaction equipment 100. Second CPU 31 reads the connection information from second flash ROM 32, or detects the connection state of external display 500 by obtaining the connection information from docking device 200 through docking device I/F 46.

Second CPU 31 determines whether or not external display 500 is connected to docking device 200 based on the obtained connection information (step S102).

In a case where external display 500 is connected to the docking device, second CPU 31 performs an allocation setting of the peripheral equipment including the display such that predetermined application A as a first application uses external display 500 as a main display (step S103). As an example of application A, the merchandise registration application (checkout counter application) is used.

The allocation setting of the display is performed by allocating the corresponding application to a target display (external display 500 or internal display 34b) as an output destination of a logic screen of the application. Accordingly, an association of a display to be used by a predetermined application is performed, and the operation screen is displayed on the display on which the allocation setting is performed during the execution of the application.

In step S103, the allocation of the main display of application A is set to external display 500, and the operation screen of application A is displayed on external display 500 during the execution of application A.

Meanwhile, in a case where external display 500 is not connected to the docking device, second CPU 31 performs the allocation setting of the display such that predetermined application B as a second application other than application A uses internal display 34b as the main display (step S104). As an example of application B, the settlement application is used.

Thereafter, if necessary, second CPU 31 starts the application corresponding to the allocation setting of the display. When transaction equipment 100 is attached to docking device 200, in a case where external display 500 is connected and the application other than application A is started, second CPU 31 performs the allocation setting of the display, and starts application A. Accordingly, application A is executed in transaction equipment 100, and the operation screen is displayed on external display 500. When transaction equipment 100 is attached to docking device 200, in a case where application A is already started, second CPU 31 switches the display of the operation screen of application A from internal display 34b to external display 500.

When transaction equipment 100 is attached to docking device 200, in a case where external display 500 is not connected and the application other than application B is started, second CPU 31 performs the allocation setting of the display, and starts application B. Accordingly, application B is executed in transaction equipment 100, and the operation screen is displayed on internal display 34b. When transaction equipment 100 is attached to docking device 200, in a case where application B is already started, second CPU 31 continues to perform the operation of application B without change.

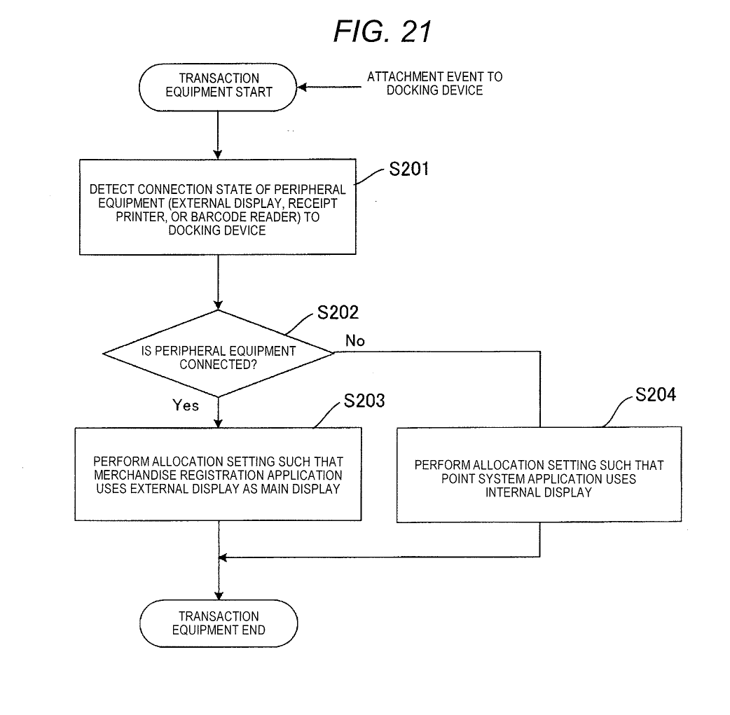

FIG. 21 is a flowchart for describing a second example of an operation procedure of transaction equipment 100 of the present exemplary embodiment. Here, portions different from those in the above-described first example will be mainly described, and the redundant description related to substantially the same procedure will be omitted in some cases.

In FIG. 21, if the attachment event of the transaction equipment to docking device 200 occurs, second CPU 31 of transaction equipment 100 detects the connection states of external display 500, receipt printer 300 and barcode reader 800 as the peripheral equipments connected to docking device 200 (step S201). Second CPU 31 determines whether or not external display 500, receipt printer 300 and barcode reader 800 are connected to docking device 200 based on the obtained connection information of the peripheral equipment (step S202).

In a case where external display 500, receipt printer 300 and barcode reader 800 are connected, second CPU 31 performs the allocation setting of the display such that the merchandise registration application as the first application uses external display 500 as the main display (step S203). Second CPU 31 performs the allocation setting of the peripheral equipment such that the merchandise registration application uses receipt printer 300 and barcode reader 800.

Meanwhile, in a case where the three peripheral equipments are not connected, second CPU 31 performs the allocation setting of the display such that a point system application as the second application uses internal display 34b as the main display (step S204).

Thereafter, second CPU 31 starts the application corresponding to the allocation setting of the display if necessary. When transaction equipment 100 is attached to docking device 200, in a case where external display 500, receipt printer 300 and barcode reader 800 are connected and the application other than the merchandise registration application is started, second CPU 31 performs the allocation setting of the display, and starts the merchandise registration application. Accordingly, the merchandise registration application is executed in transaction equipment 100, and the operation screen is displayed on external display 500. When transaction equipment 100 is attached to docking device 200, in a case where the merchandise registration application is already started, second CPU 31 switches the display of the operation screen of the merchandise registration application from internal display 34b to external display 500. Second CPU 31 operates receipt printer 300 and barcode 800 according to the operation of the merchandise registration application.

When transaction equipment 100 is attached to docking device 200, in a case where the three peripheral equipments are not connected and the application other than the point system application is started, second CPU 31 performs the allocation setting of the display, and starts the point system application. Accordingly, the point system application is executed in transaction equipment 100, and the operation screen is displayed on internal display 34b. When transaction equipment 100 is attached to docking device 200, in a case where the point system application is already started, second CPU 31 continues to perform the operation of the point system application without change. In this case, in a case where receipt printer 300 as the peripheral equipment is connected, second CPU 31 may operate receipt printer 300 according to the operation of the point system application.

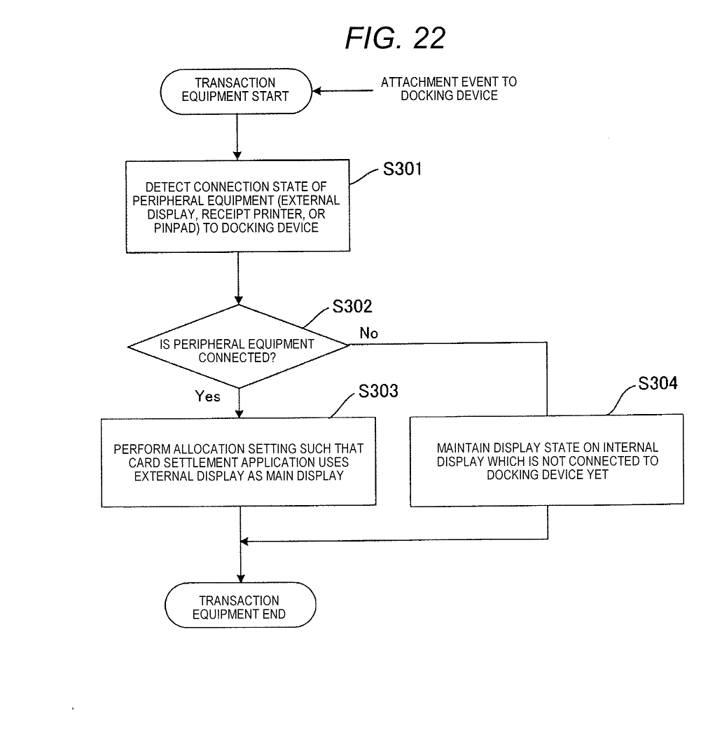

FIG. 22 is a flowchart for describing a third example of an operation procedure of transaction equipment 100 of the present exemplary embodiment. Here, portions different those in the above-described first and second examples will be mainly described, and the redundant description related to substantially the same procedure will be omitted in some cases.

In FIG. 22, if the attachment event of the transaction equipment to docking device 200 occurs, second CPU 31 of transaction equipment 100 detects the connection states of external display 500, receipt printer 300 and PINPAD 600 as the peripheral equipments connected to docking device 200 (step S301). Second CPU 31 determines whether or not external display 500, receipt printer 300 and PINPAD 600 are connected to docking device 200 based on the obtained connection information of the peripheral equipment (step S302).

In a case where external display 500, receipt printer 300 and PINPAD 600 are connected, second CPU 31 performs the allocation setting of the display such that the card settlement application as the first application uses external display 500 as the main display (step S303). Second CPU 31 performs the allocation setting of the peripheral equipment such that the card settlement application uses receipt printer 300 and PINPAD 600.

Meanwhile, in a case where the three peripheral equipments are not connected, second CPU 31 maintains the display state on internal display 34b which is not connected to docking device 200 yet (step S304). In this case, second CPU 31 continues to perform the currently started operation of the application without change.

Thereafter, second CPU 31 starts the application corresponding to the allocation setting of the display if necessary. When transaction equipment 100 is attached to docking device 200, in a case where external display 500, receipt printer 300 and PINPAD 600 are connected and the application other than the card settlement application is started, second CPU 31 performs the allocation setting of the display, and starts the card settlement application. Accordingly, the card settlement application is executed in transaction equipment 100, and the operation screen is displayed on external display 500. When transaction equipment 100 is attached to docking device 200, in a case where the card settlement application is already started, second CPU 31 switches the display of the operation screen of the card settlement application from internal display 34b to external display 500. Second CPU 31 operates receipt printer 300 and PINPAD 600 according to the operation of the card settlement application.

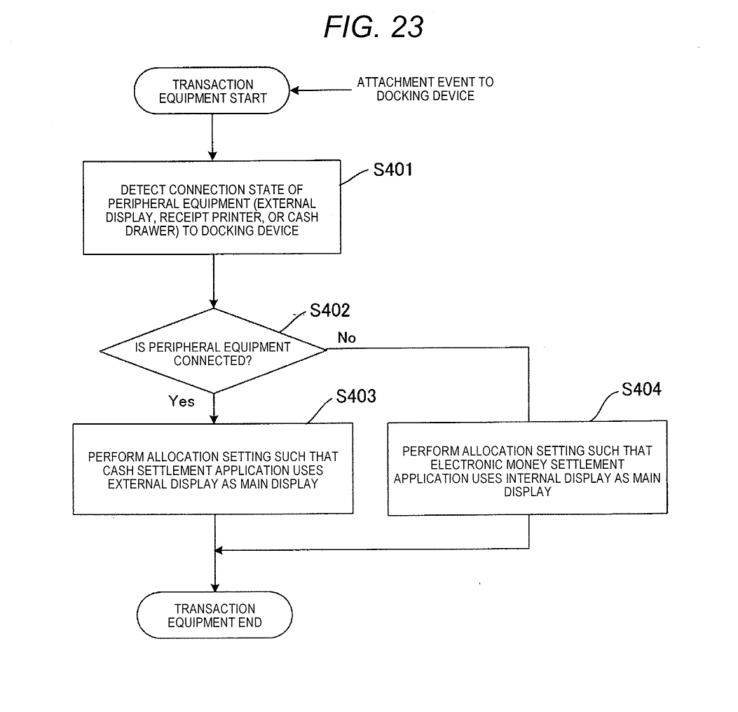

FIG. 23 is a flowchart for describing a fourth example of an operation procedure of transaction equipment 100 of the present exemplary embodiment. Here, portions different from those in the above-described first to third examples will be mainly described, and the redundant description related to substantially the same procedure will be omitted in some cases.

In FIG. 23, if the attachment event of the transaction equipment to docking device 200 occurs, second CPU 31 of transaction equipment 100 detects the connection states of external display 500, receipt printer 300 and cash drawer 400 as the peripheral equipments connected to docking device 200 (step S401). Second CPU 31 determines whether or not external display 500, receipt printer 300 and cash drawer 400 are connected to docking device 200 based on the obtained connection information of the peripheral equipment (step S402).

In a case where external display 500, receipt printer 300 and cash drawer 400 are connected, second CPU 31 performs the allocation setting of the display such that the cash settlement application as the first application uses external display 500 as the main display (step S403). Second CPU 31 performs the allocation setting of the peripheral equipment such that the cash settlement application uses receipt printer 300 and cash drawer 400.

Meanwhile, in a case where the three peripheral equipments are not connected, second CPU 31 performs the allocation setting of the display such that the electronic money settlement application as the second application uses internal display 34b as the main display (step S404).

Thereafter, if necessary, second CPU 31 starts the application corresponding to the allocation setting of the display. When transaction equipment 100 is attached to docking device 200, in a case where external display 500, receipt printer 300 and cash drawer 400 are connected and the application other than the cash settlement application is started, second CPU 31 performs the allocation setting of the display, and starts the cash settlement application. Accordingly, the cash settlement application is executed in transaction equipment 100, and the operation screen is displayed on external display 500. When transaction equipment 100 is attached to docking device 200, in a case where the cash settlement application is already started, second CPU 31 switches the display of the operation screen of the cash settlement application from internal display 34b to external display 500. Second CPU 31 operates receipt printer 300 and cash drawer 400 according to the operation of the cash settlement application.

When transaction equipment 100 is attached to docking device 200, in a case where the three peripheral equipments are not connected and the application other than the electronic money settlement application is started, second CPU 31 performs the allocation setting of the display, and starts the electronic money settlement application. Accordingly, the electronic money settlement application is executed in transaction equipment 100, and the operation screen is displayed on internal display 34b. When transaction equipment 100 is attached to docking device 200, in a case where the electronic money settlement application is already started, second CPU 31 continues to perform the operation of the electronic money settlement application without change. In this case, in a case where receipt printer 300 as the peripheral equipment is connected, second CPU 31 may operate receipt printer 300 according to the operation of the electronic money settlement application.

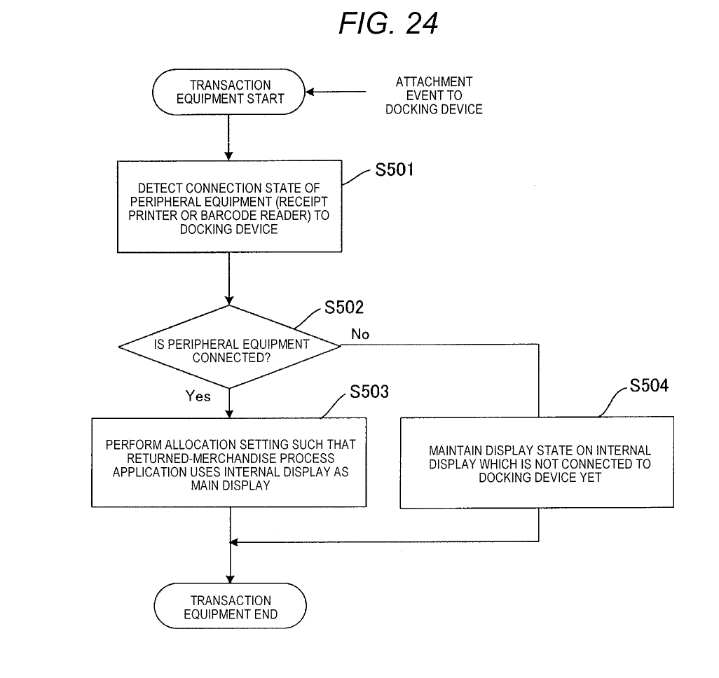

FIG. 24 is a flowchart for describing a fifth example of an operation procedure of transaction equipment 100 of the present exemplary embodiment. Here, portions different from those in the above-described first to fourth examples will be mainly described, and the redundant description related to substantially the same procedure will be omitted in some cases.

In FIG. 24, if the attachment event of the transaction equipment to docking device 200 occurs, second CPU 31 of transaction equipment 100 detects the connection states of receipt printer 300 and barcode reader 800 as the peripheral equipments connected to docking device 200 (step S501). Second CPU 31 determines whether or not receipt printer 300 and barcode reader 800 are connected to docking device 200 based on the obtained connection information of the peripheral equipment (step S502).

In a case where receipt printer 300 and barcode reader 800 are connected, second CPU 31 performs the allocation setting of the display such that the returned-merchandise process application as the first application uses internal display 34b as the main display (step S503). Second CPU 31 performs the allocation setting of the peripheral equipment such that the returned-merchandise process application uses receipt printer 300 and barcode 800.

Meanwhile, in a case where the two peripheral equipments are not connected, second CPU 31 maintains the display state on internal display 34b which is not connected to docking device 200 yet (step S504). In this case, second CPU 31 continues to perform the operation of the currently started application without change.

Thereafter, if necessary, second CPU 31 starts the application corresponding to the allocation setting of the display. When transaction equipment 100 is attached to docking device 200, in a case where receipt printer 300 and barcode reader 800 are connected and the application other than the returned-merchandise process application is already started, second CPU 31 performs the allocation setting of the display, and starts the returned-merchandise process application. Accordingly, the returned-merchandise process application is executed in transaction equipment 100, and the operation screen is displayed on internal display 34b. When transaction equipment 100 is attached to docking device 200, in a case where the returned-merchandise process application is started, the second CPU continues to perform the operation of the returned-merchandise process application without change. Second CPU 31 operates receipt printer 300 and barcode 800 according to the operation of the returned-merchandise process application.

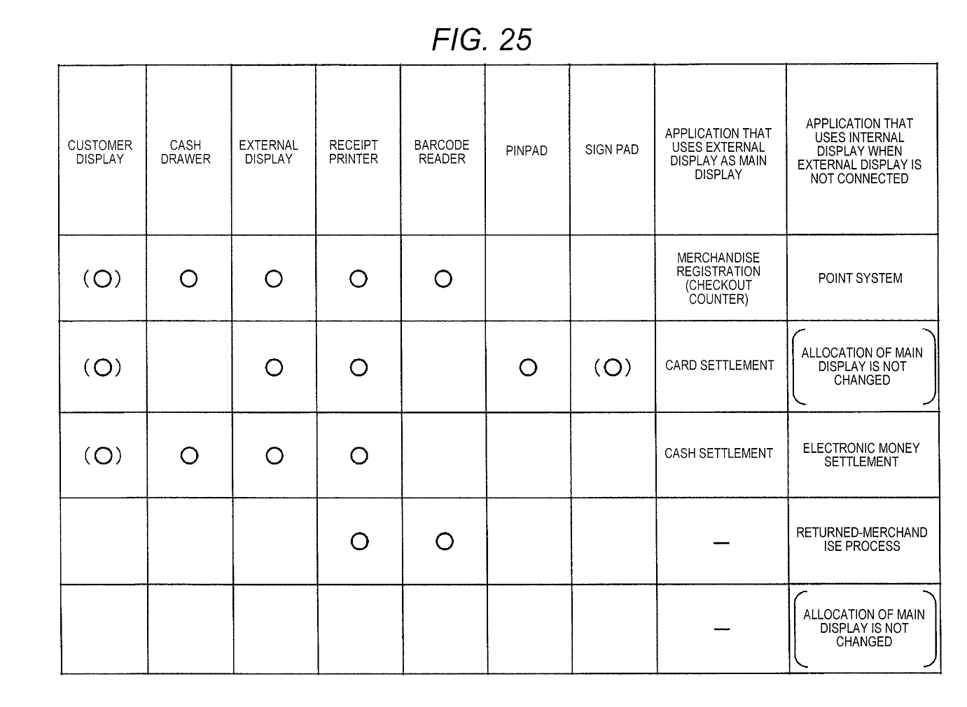

FIG. 25 is a diagram for describing a first example of the correspondence between the application and the connection state of the peripheral equipment in the transaction equipment of the present exemplary embodiment. In FIG. 25, a correspondence relationship between whether or not external display 500 is connected when the transaction equipment is attached to docking device 200 and the display allocation setting of the application of transaction equipment 100.

When the transaction equipment is attached to docking device 200, in a case where external display 500, cash drawer 400, receipt printer 300 and barcode reader 800 are connected, transaction equipment 100 performs the allocation setting of the display such that the merchandise registration application (checkout counter application) uses external display 500 as the main display. In this case, the same display allocation setting is also performed in a case where customer display 550 is further connected to docking device 200.

When the transaction equipment is attached to docking device 200, in a case where external display 500, receipt printer 300 and PINPAD 600 are connected, transaction equipment 100 performs the allocation setting of the display such that the card settlement application uses external display 500 as the main display. In this case, the same display allocation setting is performed in a case where customer display 550 and sign pad 650 are further connected to docking device 200.

When the transaction equipment is attached to docking device 200, in a case where external display 500, cash drawer 400 and receipt printer 300 are connected, transaction equipment 100 performs the allocation setting of the display such that the cash settlement application uses external display 500 as the main display. In this case, the same display allocation setting is performed in a case where customer display 550 is further connected to docking device 200.

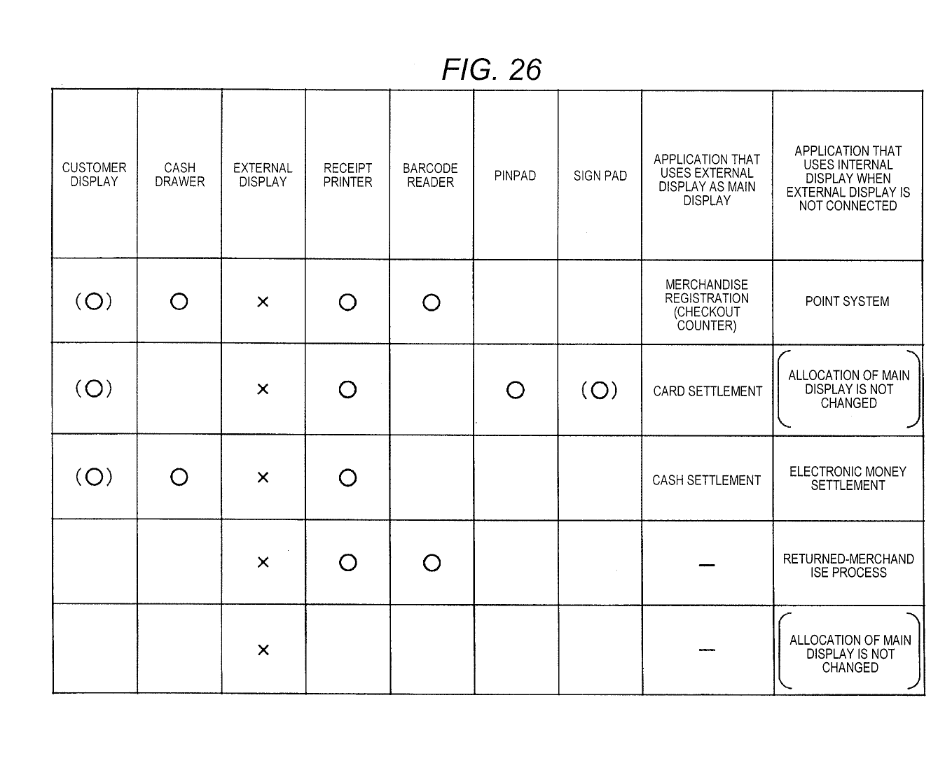

FIG. 26 is a diagram for describing a second example of the correspondence between the application and the connection state of the peripheral equipment in the transaction equipment of the present exemplary embodiment. In FIG. 26, the correspondence relationship between whether or not the peripheral equipment is connected in a case where external display 500 is not connected when the transaction equipment is attached to docking device 200 and the display allocation setting of the application of transaction equipment 100 is illustrated.

When the transaction equipment is attached to docking device 200, in a case where external display 500 is not connected and cash drawer 400, receipt printer 300 and barcode reader 800 are connected, transaction equipment 100 performs the allocation setting of the display such that the point system application uses internal display 34b as the main display.

When the transaction equipment is attached to docking device 200, in a case where external display 500 is not connected and receipt printer 300 and PINPAD 600 are connected, transaction equipment 100 maintains the most recently set display allocation setting without changing the allocation setting of the main display of the application.

When the transaction equipment is attached to docking device 200, in a case where external display 500 is not connected and cash drawer 400 and receipt printer 300 are connected, transaction equipment 100 performs the allocation setting of the display such that the electronic money settlement application uses internal display 34b as the main display.

When the transaction equipment is attached to docking device 200, in a case where external display 500 is not connected and receipt printer 300 and barcode reader 800 are connected, transaction equipment 100 performs the allocation setting of the display such that the returned-merchandise application uses internal display 34b as the main display.

When the transaction equipment is attached to docking device 200, in a case where the peripheral equipment including external display 500 is not connected, transaction equipment 100 maintains the most recently set display allocation setting without changing the allocation setting of the main display of the application.

As mentioned above, in the present exemplary embodiment, in transaction processing system 1000 using portable transaction equipment 100, it is possible to appropriately perform the allocation setting of the peripheral equipment to the application according to the connection state of the peripheral equipment by attaching transaction equipment 100 to docking device 200. For example, in a case where external display 500 is connected, it is possible to perform the allocation such that the corresponding application uses external display 500 according to a simple procedure of merely attaching the transaction equipment to docking device 200. Meanwhile, in a case where external display 500 is not connected, it is possible to perform the allocation such that the application uses internal display 34b. As mentioned above, it is possible to use the application in an appropriate state depending on whether or not the peripheral equipment is connected, and the convenience at the time of the operation of the user is improved. In a case where the application corresponding to the connected peripheral equipment is not started, it is possible to appropriately use the application through the application switching according to the connection state of the peripheral equipment without the special operation of the user by starting the peripheral equipment at the time of the attachment of the transaction equipment to docking device 200.

In transaction processing system 1000 of the present exemplary embodiment, portable transaction equipment 100 that can execute at least one of the settlement application and the business application by using internal display 34b, and docking device 200 that is connected to at least one peripheral equipment used in the settlement application or the business application and is capable of being attached to or detached from transaction equipment 100 are included.

When own equipment is attached to docking device 200, transaction equipment 100 detects the connection state of predetermined peripheral equipment to docking device 200, performs the allocation setting of the peripheral equipment such that a predetermined first application uses the predetermined peripheral equipment in a case where the predetermined peripheral equipment is connected, and performs the allocation setting of the display such that a second application different from the first application uses internal display 34b in a case where the predetermined peripheral equipment is not connected.

Accordingly, transaction equipment 100 can perform the allocation setting such that the corresponding predetermined application (for example, the merchandise registration application) uses the peripheral equipment according to the connection state of the predetermined peripheral equipment (for example, external display 500) to docking device 200 by attaching the transaction equipment to docking device 200, and the user can use the application in the appropriate state. Thus, it is possible to simplify the procedure when the application corresponding to the peripheral equipment is operated using transaction equipment 100, and it is possible to improve the convenience in a case where portable transaction equipment 100 is attached to docking device 200 and is used as the stationary transaction equipment.

In transaction processing system 1000 of the present exemplary embodiment, when own equipment is attached to docking device 200, transaction equipment 100 performs the allocation setting of the display such that the first application uses external display 500 as the main display in a case where external display 500 is connected, and performs the allocation setting of the display such that the second application uses internal display 34b as the main display in a case where external display 500 is not connected.

Accordingly, transaction equipment 100 can perform the allocation setting such that the corresponding predetermined application uses the peripheral equipment depending on whether or not external display 500 is connected to docking device 200 by attaching the transaction equipment to docking device 200, and it is possible to improve the convenience at the time of the operation of the user.

In transaction processing system 1000 of the present exemplary embodiment, when own equipment is attached to docking device 200, transaction equipment 100 starts the first application if the first application is not started in a case where the predetermined peripheral equipment is connected, and starts the second application if the second application is not started in a case where the predetermined peripheral equipment is not connected.

Accordingly, transaction equipment 100 can start and use the corresponding predetermined application according to the connection state of the predetermined peripheral equipment to docking device 200 by attaching the transaction equipment to docking device 200. In this case, the user of transaction equipment 100 such as the salesperson can use the appropriate application by merely attaching the transaction equipment to docking device 200 without the special operation, and it is possible to further improve the convenience.

In transaction processing system 1000 of the present exemplary embodiment, when own equipment is attached to docking device 200, transaction equipment 100 performs the allocation setting of the display such that the settlement application uses external display 500 as the main display in a case where external display 500 and receipt printer 300 are connected, and performs the allocation setting of the display such that the second display different from the settlement application uses internal display 34b as the main display in a case where external display 500 and receipt printer 300 are not connected.

Accordingly, when the transaction equipment is attached to docking device 200, in a case where external display 500 and receipt printer 300 are connected, transaction equipment 100 can perform the allocation setting such that the settlement application uses external display 500 as the main display. As a result, it is possible to improve the convenience when the settlement application is operated.

In transaction processing system 1000 of the present exemplary embodiment, when own equipment is attached to docking device 200, transaction equipment 100 performs the allocation setting of the display such that the merchandise registration application uses external display 500 as the main display in a case where external display 500, receipt printer 300 and barcode reader 800 are connected, and performs the allocation setting of the display such that another second application uses internal display 34b as the main display in a case where external display 500, receipt printer 300 and barcode reader 800 are not connected.

Accordingly, when the transaction equipment is attached to docking device 200, in a case where external display 500, receipt printer 300 and receipt printer 300 are connected, transaction equipment 100 can perform the allocation setting such that the merchandise registration application uses external display 500 as the main display. As a result, it is possible to improve the convenience when the merchandise registration application is operated.

Transaction equipment 100 of the present exemplary embodiment includes internal display 34b, and second CPU 31 that controls the execution of at least one of a settlement application and a business application by using internal display 34b, and docking device I/F 46 that transmits and receives signals to and from docking device 200 connected to at least one peripheral equipment used in the settlement application or the business application. Second CPU 31 detects the connection state of predetermined peripheral equipment to docking device 200 in a case where own equipment is attached to docking device 200, performs allocation setting of the peripheral equipment such that a predetermined first application uses the predetermined peripheral equipment in a case where predetermined peripheral equipment is connected, and performs allocation setting of the display such that a second application different form the first application uses internal display 34b in a case where the predetermined peripheral equipment is not connected.

In transaction processing system 1000 of the present exemplary embodiment, when own equipment is attached to docking device 200, transaction equipment 100 detects the connection state of the predetermined peripheral equipment to docking device 200, performs the allocation setting of the peripheral equipment such that the predetermined first application uses the predetermined peripheral equipment in a case where the predetermined peripheral equipment is connected, and performs the allocation setting of the display such that the second application different from the first application uses internal display 34b in a case where the predetermined peripheral equipment is not connected.

### Third Exemplary Embodiment

### Description of Operation Depending on Attachment or Detachment of Transaction Equipment to or from Docking Device

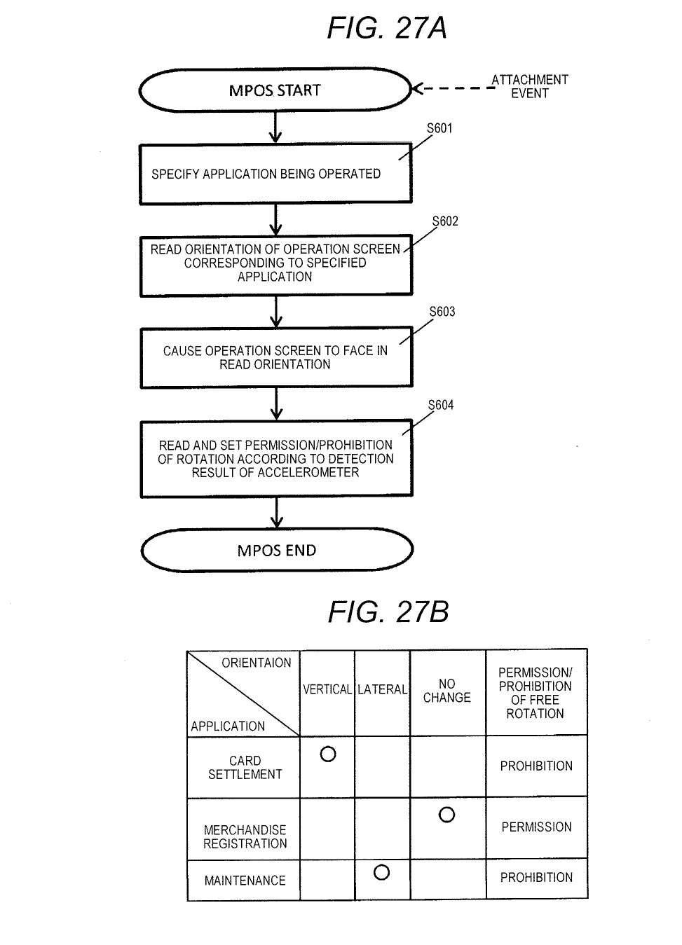

In a third exemplary embodiment, the operation depending on the attachment or the detachment of transaction equipment 100 to or from docking device 200 will be described with reference to FIGS. 27A and 27B and the subsequent drawings. The same configurations and operations as the configurations and operations described in the above-described first exemplary embodiment will be assigned the same reference numerals, and the description thereof will be omitted or simplified.

In the following description, for example, it is assumed that a case where transaction equipment 100 is attached to docking device 200 is a case where transaction equipment 100 is attached by being held in equipment holding space ECPV of docking device 200, locking part J2 is fixed through a tool such as a driver and is physically fixed, and device authentication controller 63 authenticates that correct transaction equipment 100 is attached and is electrically connected to docking device 200 as the challenge response process between transaction equipment 100 and docking device 200. In transaction equipment 100, second CPU 31 controls the execution of a predetermined application, and functions as an application controller that performs the communication connection and authentication with docking device 200 connected to at least one peripheral equipment used in the application. Second CPU 31 determines that transaction equipment 100 is attached to docking device 200 in a state in which the authentication succeeds.

In the following description, it is assumed that a case where transaction equipment 100 is detached from docking device 200 is, for example, a case that satisfies at least one of a case where transaction equipment 100 is detached from equipment holding space ECPV of docking device 200, a case where the physical fixation of transaction equipment 100 to docking device 200 is released as the result in which the locked state of locking part J2 is released, and a case where an abnormality result is obtained in the challenge response process between transaction equipment 100 and docking device 200 and the authentication fails. In transaction equipment 100, second CPU 31 determines that transaction equipment 100 is detached from docking device 200 in a state in which the authentication fails.

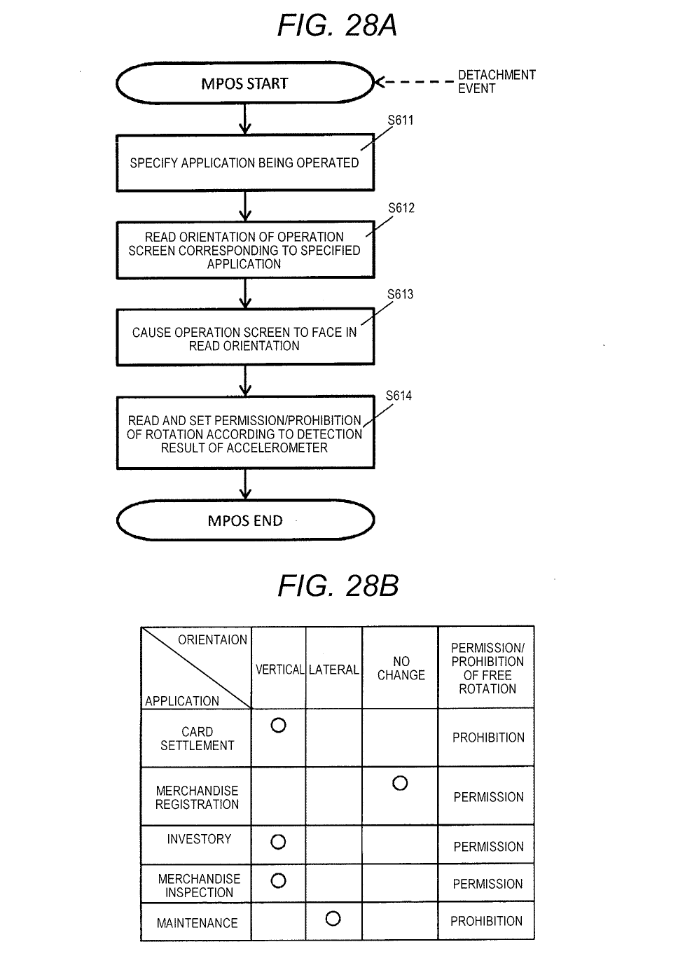

Initially, a first example of an operation in which transaction equipment 100 is attached to docking device 200 or is detached from docking device 200 will be described with reference to FIGS. 27A to 28B. In FIG. 27A, the operation of transaction equipment (MPOS) 100 in a case where transaction equipment 100 is normally attached to docking device 200 is illustrated. In this case, second CPU 31 of transaction equipment 100 specifies the (started) application which is already operated before the attachment (S601). Second CPU 31 reads the orientation of the operation screen corresponding to the specified application from the attachment table previously stored in second flash ROM 32 (S602).

FIG. 27B shows an example of the attachment table, and the orientation of the operation screen of each application of “card settlement”, “merchandise registration (checkout counter)” or “maintenance” at the time of the attachment and the matters of the permission or prohibition of the free rotation at the time of the detachment are stored. The operation screen that displays the application of “card settlement” faces in the vertical orientation, and the free rotation is prohibited. The operation screen that displays the application “merchandise registration” does not face in the vertical direction or a lateral orientation, and is set such that the orientation at the time of the attachment is maintained “without change”, and the free rotation thereof is permitted. According to such an aspect, it is possible to prompt the user to set an appropriate orientation. The operation screen that displays the application of “maintenance” faces in the lateral orientation, and the free rotation is prohibited.

Subsequently, internal display (monitor) 34b sets the orientation of the operation screen, and displays the operation screen according to the orientation read by second CPU 31 from the attachment table according to the operated application (S603). That is, internal display 34b determines the orientation of the operation screen depending on the type of a predetermined application displayed on the operation screen. Specifically, in the present example, in a case where the application of “card settlement” is displayed on the operation screen, internal display 34b sets the orientation of the operation screen to face in the vertical orientation. In a case where the application of “merchandise registration” is displayed on the operation screen, internal display 34b maintains the orientation of the operation screen in the orientation before the attachment without change. In a case where the application of “maintenance” is displayed on the operation screen, internal display 34b sets the orientation of the operation screen to face in the lateral orientation.

For a period during which transaction equipment 100 is attached to docking device 200, in a case where accelerometer 45 detects accelerations of transaction equipment 100 in an X-axis direction, a Y-axis direction and a Z-axis direction (see three axis directions shown in FIG. 3), the accelerometer outputs the detection result to second CPU 31. Internal display 34b that receives the detection result from second CPU 31 sets the orientation according to the permission or prohibition of the free rotation of the attachment table. For example, in a case where the application of “card settlement” or “maintenance” is displayed, internal display 34b prohibits the rotation of the operation screen, and fixes the orientation of the operation screen (S604). Meanwhile, in a case where the application of the merchandise registration is displayed, internal display 34b rotates and changes the orientation of the operation screen (S604). That is, internal display 34b determines whether or not the operation screen is rotated depending on the type of the predetermined application displayed on the operation screen.

The order of the processes of S603 and S604 in FIG. 27A may be reversed. That is, after the orientation of the operation screen is set in response to the detection of the accelerometer, internal display 34b may display the operation screen.

In FIG. 28A, the operation of transaction equipment (MPOS) 100 in a case where transaction equipment 100 is normally detached from docking device 200 after the process of FIG. 27A is illustrated. In this case, second CPU 31 of transaction equipment 100 specifies the (started) application which is already operated before the detachment (S611). Second CPU 31 reads the orientation of the operation screen corresponding to the specified application from the detachment table previously stored in second flash ROM 32 (S612).

FIG. 28B shows an example of the detachment table, and the orientation of the operation screen of each application of “card settlement”, “merchandise registration (checkout counter)”, “inventory”, “merchandise inspection” and “maintenance” at the time of the detachment from docking device 200 and the matters of the permission or prohibition of the free rotation at the time of the detachment are stored. The operation screen that displays the application of “card settlement” faces in the vertical orientation, and the free rotation is prohibited. The operation screen that displays the application of “merchandise registration” does not face in the vertical orientation or the lateral orientation, and is set such that the orientation at the time of the attachment is maintained “without change”, and the free rotation is permitted. According to such an aspect, it is possible to prompt the user to set an appropriate orientation. The operation screen that displays the application of “inventory” faces in the vertical orientation, and the free rotation is permitted. The operation screen that displays the application of “merchandise inspection” faces in the vertical orientation, and the free rotation is permitted. The operation screen that displays the application of “maintenance” faces in the lateral orientation, and the free rotation is prohibited.

Subsequently, internal display (monitor) 34b sets the orientation of the operation screen and displays the operation screen according to the orientation read by second CPU 31 from the detachment table (S613). That is, internal display 34b determines the orientation of the operation screen depending on the type of the predetermined application displayed on the operation screen. Specifically, in the present example, in a case where the application of “card settlement” is displayed on the operation screen, internal display 34b sets the orientation of the operation screen to face in the vertical orientation. In a case where the application of “merchandise registration” is displayed on the operation screen, internal display 34b maintains the orientation of the operation screen in the same orientation as the orientation at the time of the attachment. In a case where the application of “inventory” is displayed on the operation screen, internal display 34b sets the orientation of the operation screen to face in the vertical orientation. In a case where the application of “merchandise inspection” is displayed on the operation screen, internal display 34b sets the orientation of the operation screen to face in the vertical direction. In a case where the application of “maintenance” is displayed on the operation screen, internal display 34b sets the orientation of the operation screen to face in the lateral orientation.

For a period during which transaction equipment 100 is attached to docking device 200, in a case where accelerometer 45 detects accelerations of transaction equipment 100 in an X-axis direction, a Y-axis direction and a Z-axis direction (see three axis directions shown in FIG. 3), the accelerometer outputs the detection result to second CPU 31. Internal display 34b that receives the detection result from second CPU 31 sets the orientation according to the permission or prohibition of the free rotation of the table. For example, in a case where the application of “card settlement” or “maintenance” is displayed, internal display 34b prohibits the rotation of the operation screen, and fixes the orientation of the operation screen (S614). Meanwhile, in a case where the application of “merchandise registration”, “inventory” or “merchandise inspection” is displayed, internal display 34b rotates and changes the orientation of the operation screen (S614). That is, internal display 34b determines whether or not the operation screen is rotated depending on the type of the predetermined application displayed on the operation screen.

The order of the processes of S613 and S614 in FIG. 28A may be reversed. That is, after the orientation of the operation screen is set in response to the detection of the acceleration, internal display 34b may display the operation screen.

As described above, in transaction equipment 100 of the present exemplary embodiment, internal display 34b changes a setting related to the state of whether or not the operation screen is rotated between the time of the attachment of transaction equipment 100 to docking device 200 and the time of the detachment of transaction equipment 100 from docking device 200. Specifically, the attachment table of FIG. 27B is used at the time of the attachment, and the detachment table of FIG. 28B is used at the time of the detachment. Accordingly, the state of whether the operation screen of transaction equipment 100 is rotated becomes appropriate depending on the use situation, and thus, the convenience is improved.

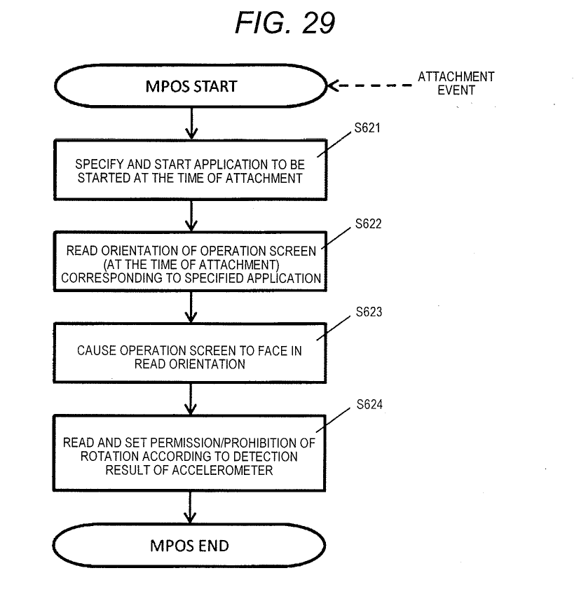

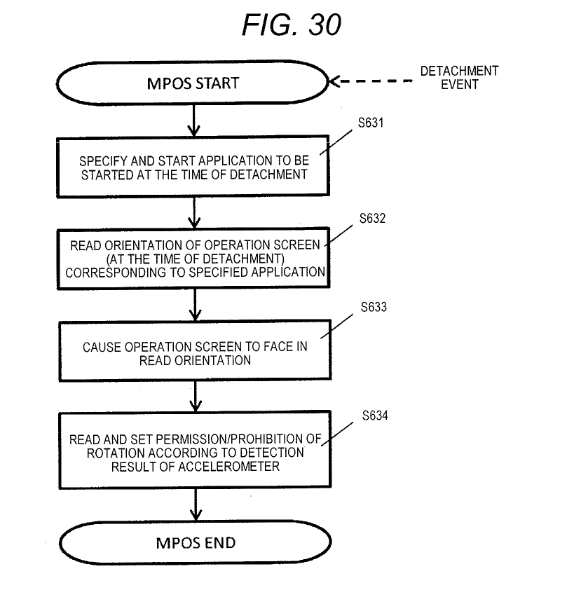

Hereinafter, a second example of an operation in which transaction equipment 100 is attached to docking device 200 or is detached from docking device 200 will be described with reference to FIGS. 29 and 30. In FIG. 29, the operation of transaction equipment (MPOS) 100 in a case where transaction equipment 100 is normally attached to docking device 200 is illustrated. In this case, second CPU 31 of transaction equipment 100 specifies and starts the application to be started at the time of the attachment (S621). Second CPU 31 reads the orientation of the operation screen corresponding to the specified application from the attachment table (FIG. 27B) previously stored in second flash ROM 32 (S622). Hereinafter, the processes of S623 and S624 are the same as S603 and S604 of FIG. 27A.

That is, in the present example, second CPU 31 starts the predetermined application at the time of the attachment of transaction equipment 100 to docking device 200, and internal display 34b determines the orientation of the operation screen depending on the type of the application. The application to be started at the time of the attachment is previously determined, and, for example, the type of the application can be stored in second flash ROM 32.

In FIG. 30, the operation of transaction equipment (MPOS) 100 in a case where transaction equipment 100 is normally detached from docking device 200 after the process of FIG. 29 is illustrated. In this case, second CPU 31 of transaction equipment 100 specifies and starts the application to be started at the time of the detachment (S631). Second CPU 31 reads the orientation of the operation screen corresponding to the specified application from the detachment table (FIG. 28B) previously stored in second flash ROM 32 (S632). Hereinafter, the processes of S633 and S634 are the same as S613 and S614 of FIG. 28A.

That is, in the present example, second CPU 31 starts the predetermined application at the time of the detachment of transaction equipment 100 from docking device 200, and internal display 34b determines the orientation of the operation screen depending on the type of the application. The application to be started at the time of the detachment is previously determined, and, for example, the type of the application can be stored in second flash ROM 32.

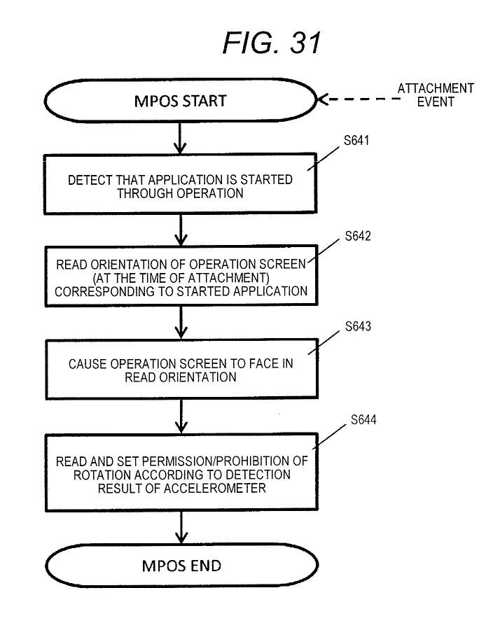

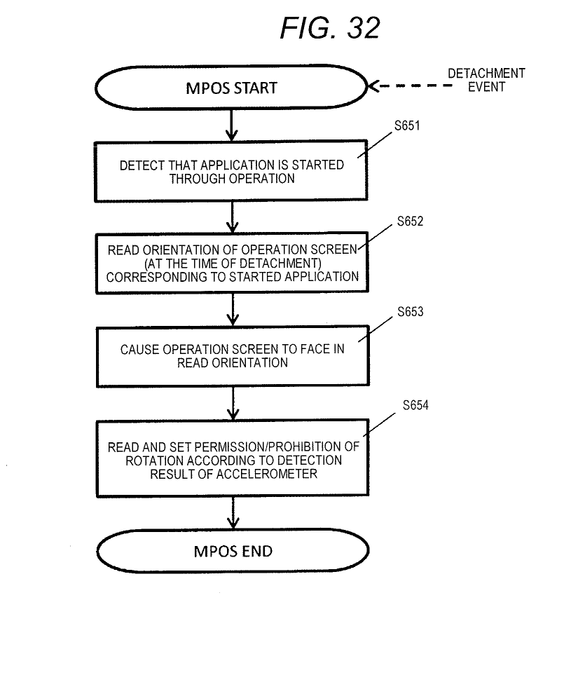

Hereinafter, a third example of an operation in which transaction equipment 100 is attached to docking device 200 or is detached from docking device 200 will be described with reference to FIGS. 31 and 32. In FIG. 31, the operation of transaction equipment (MPOS) 100 in a case where transaction equipment 100 is normally attached to docking device 200 is illustrated. Second CPU 31 of transaction equipment 100 detects a start operation (for example, an input operation on second touch-input detector 34a) of a predetermined application by the user (S641). Second CPU 31 reads the orientation of the operation screen corresponding to the started application from the attachment table (FIG. 27B) previously stored in second flash ROM 32 (S642). Hereinafter, the processes of S643 and S644 are the same as S603 and S604 of FIG. 27A.

That is, in the present example, in a case where the start operation of the predetermined application is performed after transaction equipment 100 is attached to docking device 200, second CPU 31 starts the predetermined application, and internal display 34b determines the orientation of the operation screen depending on the type of the application.

In FIG. 32, the operation of transaction equipment (MPOS) 100 in a case where transaction equipment 100 is normally detached from docking device 200 after the process of FIG. 31 is illustrated. Second CPU 31 of transaction equipment 100 detects the start operation (for example, the input operation on second touch-input detector 34a) of the predetermined application by the user (S651). Second CPU 31 reads the orientation of the operation screen corresponding to the started application from the detachment table (FIG. 28B) previously stored in second flash ROM 32 (S652). Hereinafter, the processes S653 and S654 are the same as S613 and S614 of FIG. 28A.

That is, in the present example, in a case where the start operation of the predetermined application is performed after transaction equipment 100 is detached from docking device 200, second CPU 31 starts the predetermined application, and internal display 34b determines the orientation of the operation screen depending on the type of the application.

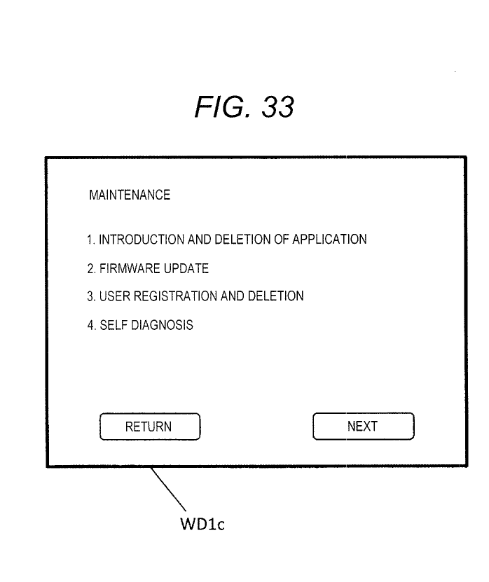

FIG. 33 shows an example of operation screen WD1c of the application of “maintenance”. As shown in the tables of FIGS. 27B and 28B, since the orientation of the operation screen of the present application is the lateral orientation and the free rotation is prohibited, the orientation of the screen is constantly the lateral orientation as shown in FIG. 33.

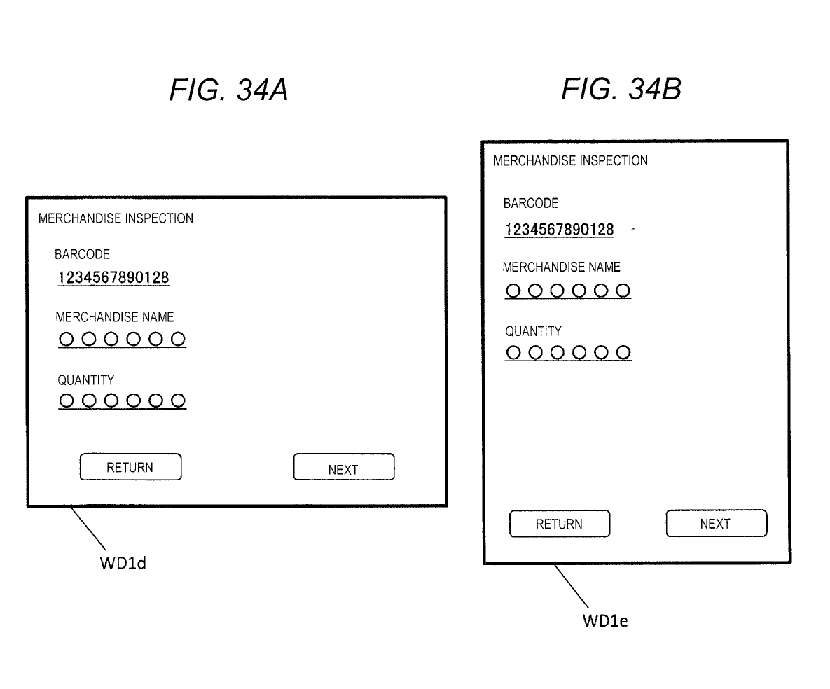

FIG. 34A is an example (WD1d) of the operation screen of the application of “merchandise inspection” facing in the lateral orientation, and FIG. 34B is an example (WD1e) of the operation screen facing in the vertical orientation. As shown in the table of FIG. 28B, since the orientation of the operation screen of the present application is the vertical orientation but the free rotation is permitted, both the operation screens facing in the lateral orientation and the vertical orientation are present as shown in FIGS. 34A and 34B.

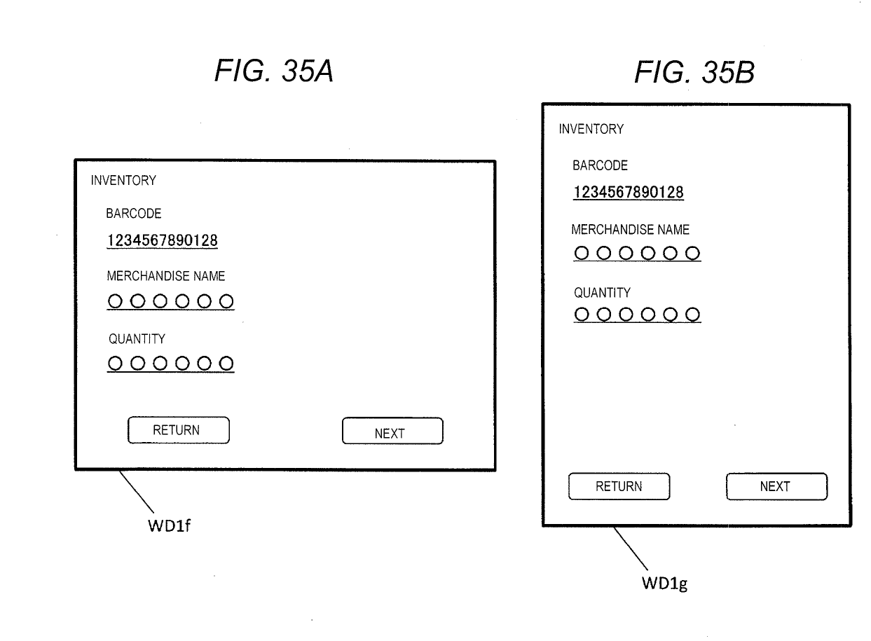

FIG. 35A is an example of the operation screen of the application of “inventory” facing in the lateral orientation, and FIG. 35B is an example of the operation screen of the application of “inventory” facing in the vertical orientation. Operation screens WD1f or WD1g as the application of “merchandise inspection” shown in FIG. 34A or FIG. 24B may be adopted. The example of the screen of the application of “merchandise registration (checkout counter)” is illustrated, but the same operation screen as FIG. 34A, FIG. 34B, FIG. 35A or FIG. 35B may be adopted. Examples of operation screens WD1a and WD1b of the application of “card settlement” are respectively shown in FIGS. 7A and 7B.

As mentioned above, transaction equipment 100 of the present exemplary embodiment includes application controller (second CPU) 31 that controls the execution of a predetermined application, and performs communication connection and authentication with respect to docking device 200 connected to at least one peripheral equipment used in the application. Transaction equipment 100 includes monitor (internal display) 34b that displays a predetermined operation screen so as to be rotatable, and monitor 34b changes a setting related to a state of whether an operation screen is rotated between the time of the attachment of transaction equipment 100 to docking device 200 and the time of the detachment of transaction equipment 100 from docking device 200.

As stated above, a transaction processing method in transaction equipment 100 of the present exemplary embodiment is a transaction processing method in transaction equipment 100 including application controller 31 that controls the execution of a predetermined application, and performs communication connection and authentication with respect to docking device 200 connected to at least one peripheral equipment used in the application. Transaction equipment 100 includes monitor 34b that displays a predetermined operation screen so as to be rotatable, and monitor 34b changes a setting related to a state of whether an operation screen is rotated between the time of the attachment of transaction equipment 100 to docking device 200 and the time of the detachment of transaction equipment 100 from docking device 200.

As stated above, a transaction processing program in transaction equipment 100 of the present exemplary embodiment is a transaction processing program in transaction equipment 100 including application controller 31 that controls the execution of a predetermined application, and performs communication connection and authentication with respect to docking device 200 connected to at least one peripheral equipment used in the application. Transaction equipment 100 includes monitor 34b that displays a predetermined operation screen so as to be rotatable, and causes monitor 34b to change a setting related to a state of whether an operation screen is rotated between the time of the attachment of transaction equipment 100 to docking device 200 and the time of the detachment of transaction equipment 100 from docking device 200.

As mentioned above, internal display 34b in transaction equipment 100 changes a setting related to a state of whether or not an operation screen is rotated between the time of the attachment of transaction equipment 100 to docking device 200 and the time of the detachment of transaction equipment 100 from docking device 200. Accordingly, the state of whether the operation screen of transaction equipment 100 is rotated becomes appropriate depending on the use situation, and thus, the convenience is improved.

Monitor 34b may prohibit the rotation of the operation screen at the time of the attachment of transaction equipment 100 to docking device 200, and may fix the orientation of the operation screen. Therefore, it is possible to maintain the orientation of the operation screen at the time of the attachment in an appropriate orientation.

Monitor 34b may determine the orientation of the operation screen depending on the type of the predetermined application displayed on the operation screen at the time of the attachment of transaction equipment 100 to docking device 200. Thus, it is possible to set the orientation of the operation screen at the time of the attachment to be in an appropriate orientation depending on the type of the application.

Monitor 34b may determine whether or not the operation screen is rotated at the time of the detachment of transaction equipment 100 is detached from docking device 200. Accordingly, it is possible to set the orientation of the operation screen at the time of the detachment to be in an appropriate orientation again.

Monitor 34b may maintain the orientation of the operation screen at the time of the detachment of transaction equipment 100 from docking device 200 in the same orientation as the orientation at the time of the attachment of the transaction equipment from docking device 200. Accordingly, it is possible to maintain the orientation of the operation screen at the time of the detachment in the same orientation as the appropriate orientation at the time of the attachment.

Monitor 34b may determine the orientation of the operation screen at the time of the detachment of transaction equipment 100 from docking device 200 depending on the type of the predetermined application displayed on the operation screen. Accordingly, it is possible to set the orientation of the operation screen at the time of the detachment to be in the appropriate orientation depending on the type of the application.

Monitor 34b may determine whether or not the operation screen is rotated at the time of the detachment of transaction equipment 100 from docking device 200 depending on the type of the predetermined application displayed on the operation screen. Accordingly, it is possible to set the orientation of the operation screen at the time of the detachment to be in the appropriate orientation again while considering the type of the application.

Application controller 31 may start the predetermined application at the time of the attachment of transaction equipment 100 to docking device 200, and monitor 34b may determine the orientation of the operation screen depending to the type of the application. Accordingly, it is possible to automatically start the application at the time of the attachment, and it is possible to set the orientation of the operation screen to be in the appropriate orientation depending on the type of the application.

In a case where the start operation of the predetermined application is performed after transaction equipment 100 is attached to docking device 200, application controller 31 may start the predetermined application, and monitor 34b may determine the orientation of the operation screen depending on the type of the application. Accordingly, it is possible to detect the start operation of the application by the user at the time of the attachment, and it is possible to set the orientation of the operation screen to be in the appropriate orientation depending on the type of the application.

Although the exemplary embodiments of the transaction processing system according to the present invention have been described with reference to the drawings, the present disclosure is not limited to the exemplary embodiments. It will be apparent to those skilled in the art that various changes, modifications, substitutions, additions, deletions and their equivalents may be made without departing from the claims, and would fall within the technical scope of the present disclosure.

For example, there is provided a transaction processing system including portable transaction equipment that includes a monitor, and a controller capable of executing at least one of a settlement application and a business application by using the monitor, and a docking device that is connected to at least one peripheral equipment used in the settlement application or the business application, and is capable of being attached to or detached from the transaction equipment. The peripheral equipment may be an external display having a display area wider than that of the monitor. The controller of the transaction equipment may switch to the external display from the monitor, and may display an operation screen of the settlement application or the business application, which is displayed on the monitor, on the external display through the docking device in response to the attachment of the transaction equipment to the docking device.

The controller of the transaction equipment may further display an operation screen of another application other than the application displayed on the external display on the monitor.

The controller of the transaction equipment may display a part of the operation screen of the settlement application or the business application on the external display, and may display the remaining operation screen of the settlement application or the business application on the monitor.

The controller of the transaction equipment may display the operation screen of the settlement application or the business application, which is displayed on the external display, on the monitor in response to the detachment of the transaction equipment from the docking device.

The controller of the transaction equipment may continue to display the operation screen of the other application displayed on the monitor in response to the detachment of the transaction equipment from the docking device.

The controller of the transaction equipment may determine an application to be displayed on the monitor based on any one of a classification of the settlement application or the business application displayed on the external display, an operation screen and a processing state in response to the detachment of the transaction equipment from the docking device, and may display the operation screen of the determined application on the monitor.

The controller of the transaction equipment may display the operation screen of the settlement application on the monitor before the transaction equipment is attached to the docking device, and may display the operation screen of the settlement application on the external display in response to the attachment of the transaction equipment to the docking device.

The controller of the transaction equipment may display the operation screen of the business application related to the merchandise registration on the monitor before the transaction equipment is attached to the docking device, or may display the operation screen of the business application related to the merchandise registration on the external display in response to the attachment of the transaction equipment to the docking device, and may display the operation screen of the settlement application on the monitor.

A transaction processing method is, for example, a transaction processing method in a transaction processing system that includes portable transaction equipment which includes a monitor and is capable of executing at least one of the settlement application and the business application by using the monitor, and a docking device which is connected to at least one peripheral equipment used in the settlement application or the business application and is capable of being attached to and detached from the transaction equipment. The peripheral equipment may be an external display having a display area wider than that of the monitor. The transaction equipment may display the operation screen of the settlement application or the business application on the monitor, and may output data regarding the operation screen of the settlement application or the business application displayed on the monitor to the docking device if the transaction equipment is attached to the docking device. The docking device may output the data regarding the operation screen from the transaction equipment to the external display. The external display may display the operation screen of the settlement application or the business application by using the data regarding the operation screen from the docking device.

For example, the transaction equipment includes: a monitor, a controller that controls the execution of at least one of a settlement application and a business application by using the monitor, and an authentication controller that performs communication connection and authentication with respect to a docking device connected to at least one peripheral equipment used in the settlement application or the business application. Here, the peripheral equipment is an external display having a display area wider than that of the monitor. In a case where the authentication controller authenticates the communication and attachment of the transaction equipment with and to the docking device, the controller may switch from the monitor to the external display, and may display an operation screen of the settlement application or the business application, which is displayed on the monitor, on the external display through the docking device.

For example, there is provided a transaction processing system including portable transaction equipment that includes a monitor, and a controller that is capable of executing at least one of a settlement application and a business application by using the monitor, and a docking device that is connected to at least one peripheral equipment used in the settlement application or the business application and is capable of being attached to and detached from the transaction equipment. When the own equipment is attached to the docking device, the controller of the transaction equipment may detect a connection state of predetermined peripheral equipment to the docking device, and may perform an allocation setting of peripheral equipment such that a predetermined first application uses the predetermined peripheral equipment in a case where the predetermined peripheral equipment is connected, and may perform an allocation setting of a display such that a second application different from the predetermined first application uses the monitor in a case where the predetermined peripheral equipment is not connected.

When the own equipment is attached to the docking device, the controller of the transaction equipment may perform an allocation setting of a display such that the first application uses the external display as a main display in a case where the external display is connected as the predetermined peripheral equipment, and may perform an allocation setting of a display such that the second application uses the monitor as a main display in a case where the external display is not connected.

When the own equipment is attached to the docking device, the controller of the transaction equipment may start the first application if the first application is not started in a case where the predetermined peripheral equipment is connected, and may start the second application if the second application is not started in a case where the predetermined peripheral equipment is not connected.

When the own device is attached to the docking device, the controller of the transaction equipment may perform an allocation setting of a display such that the settlement application uses the external display as a main display in a case where the external display and a receipt printer are connected as the predetermined peripheral equipment, and may perform an allocation setting of a display such that a second application different from the settlement application uses the monitor as a main display in a case where the external display and the receipt printer are not connected.

When the own equipment is attached to the docking device, the controller of the transaction equipment may perform an allocation setting of a display such that a merchandise registration application as the business application uses the external display as a main display in a case where the external display, a receipt printer and a barcode reader are connected as the predetermined peripheral equipment, and may perform an allocation setting of a display such that a second display different from the merchandise registration application uses the monitor as a main display in a case where the external display, the receipt printer and the barcode reader are not connected.

For example, portable transaction equipment capable of being attached to and detached from a docking device includes a monitor, a controller that controls the execution of at least one of a settlement application and a business application by using the monitor, and a interface that transmits and receives a signal to and from the docking device connected to at least one peripheral equipment used in the settlement application or the business application. The controller may detect a connection state of predetermined peripheral equipment to the docking device in a case where the own equipment is attached to the docking device, may perform an allocation setting of peripheral equipment such that a predetermined first application uses the predetermined peripheral equipment in a case where the predetermined peripheral equipment is connected, and may perform an allocation setting of a display such that a second application different from the first application uses the monitor in a case where the predetermined peripheral equipment is not connected.

For example, a transaction processing method is a transaction processing method in a transaction processing system that includes portable transaction equipment which includes a monitor, and is capable of executing at least one of a settlement application and a business application by using the monitor, and a docking device which is connected to at least one peripheral equipment used in the settlement application or the business application and is capable of being attached to and detached from the transaction equipment. When the own equipment is attached to the docking device, the transaction equipment may detect a connection state of predetermined peripheral equipment to the docking device, may perform an allocation setting of peripheral equipment such that a predetermined first application uses the predetermined peripheral equipment in a case where the predetermined peripheral equipment is connected, and may perform an allocation setting of a display such that a second application different from the first application that uses the monitor in a case where the predetermined peripheral equipment is not connected.

For example, the transaction equipment includes a controller that controls the execution of a predetermined application, and performs communication connection and authentication with respect to the docking device connected to at least one peripheral equipment used in the application. The controller may change a setting related to a state of whether or not the operation screen displayed on the monitor is rotated between the time of the attachment of the transaction equipment to the docking device and the time of the detachment of the transaction equipment from the docking device.

When the transaction equipment is attached to the docking device, the controller may prohibit the rotation of the operation screen displayed on the monitor and may fix the orientation of the operation screen.

When the transaction equipment is attached to the docking device, the controller may determine the orientation of the operation screen depending on the type of the predetermined application displayed on the operation screen displayed on the monitor.

When the transaction equipment is detached from the docking device, the controller may determine whether or not the operation screen displayed on the monitor is rotated.

When the transaction equipment is detached from the docking device, the monitor may maintain the orientation of the operation screen in the same orientation as the orientation at the time of the attachment of the transaction equipment to the docking device.

When the transaction equipment is detached from the docking device, the controller may determine the orientation of the operation screen depending on the type of the predetermined application displayed on the operation screen displayed on the monitor.

When the transaction equipment is detached from the docking device, the controller may determine whether or not the operation screen is rotated depending on the type of the predetermined application displayed on the operation screen displayed on the monitor.

The controller may start the predetermined application at the time of the attachment of the transaction equipment to the docking device, and the controller may determine the orientation of the operation screen displayed on the monitor depending on the type of the application.

After the transaction equipment is attached to the docking device, the controller may start the predetermined application in a case where a start operation of a predetermined application is carried out, and the controller may determine the orientation the operation screen displayed on the monitor depending on the type of the application.

For example, a transaction processing method is a transaction processing method in transaction equipment that includes a controller which controls the execution of a predetermined application and performs communication connection and authentication with respect to a docking device connected to at least one peripheral equipment used in the application. The controller of the transaction equipment may change a setting related to a state of whether or not the operation screen displayed on the monitor is rotated between the time of the attachment of the transaction equipment to the docking device and the time of the detachment of the transaction equipment from the docking device.

In addition, a transaction processing system, transaction equipment and a transaction processing method obtained by appropriately combining the above-described first exemplary embodiment to third exemplary embodiment may be constructed.

It has been described in the above-described exemplary embodiments that the settlement process using the credit cards (more specifically, a magnetic credit card, a contact IC credit card, and a non-contact IC credit card) is used as an example of a card transaction of a purchaser, but is not limited to the settlement process using the credit card. For example, the present disclosure may be applied to a settlement process using a debit card, electronic money, a prepaid card, a postpaid card, a point card, an electronic coupon, an electronic merchandise certificate or cash.

What is claimed is:

1. A transaction processing system comprising:
portable transaction equipment that includes a monitor, and a controller capable of executing at least one of a settlement application and a business application by using the monitor; and
a docking device that is connected to at least one peripheral equipment used in the settlement application or the business application and is capable of being attached to and detached from the transaction equipment,
wherein the peripheral equipment is an external display having a display area wider than that of the monitor, and
the controller of the transaction equipment switches from the monitor to the external display, and displays an operation screen of the settlement application or the business application, which is displayed on the monitor, on the external display through the docking device in response to the attachment of the transaction equipment to the docking device.

2. The transaction processing system according to claim 1,
wherein the controller of the transaction equipment displays an operation screen of another application other than the application, which is displayed on the external display, on the monitor.

3. The transaction processing system according to claim 1,
wherein the controller of the transaction equipment display a part of the operation screen of the settlement application or the business application on the external display, and displays the remaining operation screen of the settlement application or the business application on the monitor.

4. The transaction processing system according to claim 1,
wherein the controller of the transaction equipment displays the operation screen of the settlement application or the business application, which is displayed on the external display, on the monitor in response to the detachment of the transaction equipment from the docking device.

5. The transaction processing system according to claim 2,
wherein the controller of the transaction equipment continues to display the operation screen of the other application displayed on the monitor in response to the detachment of the transaction equipment from the docking device.

6. The transaction processing system according to claim 1,
wherein the controller of the transaction equipment determines an application to be displayed on the monitor based on any one of a type, an operation screen and a process state of the settlement application or the business application displayed on the external display in response to the detachment of the transaction equipment from the docking device, and displays an operation screen of the determined application on the monitor.

7. The transaction processing system according to claim 1,
wherein the controller of the transaction equipment displays an operation screen of the settlement application on the monitor before the transaction equipment is attached to the docking device, and displays the operation screen of the settlement application on the external display in response to the attachment of the transaction equipment to the docking device.

8. The transaction processing system according to claim 2,
wherein the controller of the transaction equipment displays an operation screen of a business application related to merchandise registration on the monitor before the transaction equipment is attached to the docking device, and display the operation screen of the business application related to the merchandise registration on the external display in response to the attachment of the transaction equipment to the docking device, and display the operation screen of the settlement application on the monitor.

9. A transaction processing method in a transaction processing system that includes portable transaction equipment which includes a monitor and is capable of executing at least one of a settlement application and a business application by using the monitor, and a docking device which is connected to at least one peripheral equipment used in the settlement application or the business application and is capable of being attached to and detached from the transaction equipment,
wherein the peripheral equipment is an external display having a display area wider than that of the monitor,
the transaction equipment displays an operation screen of the settlement application or the business application on the monitor, and outputs data regarding the operation screen of the settlement application or the business application displayed on the monitor to the docking device if the transaction equipment is attached to the docking device,
the docking device outputs the data regarding the operation screen from the transaction equipment to the external display, and
the external display displays the operation screen of the settlement application or the business application by using the data regarding the operation screen from the docking device.

10. Transaction equipment comprising:
a monitor;
a controller that controls the execution of at least one of a settlement application and a business application by using the monitor; and
an authentication controller that performs communication connection and authentication with respect to a docking device connected to at least one peripheral equipment used in the settlement application or the business application,
wherein the peripheral equipment is an external display having a display area wider than that of the monitor, and
the controller switches from the monitor to the external display, and displays an operation screen of the settlement application or the business application, which is displayed on the monitor, on the external display through the docking device in a case where the authentication controller authenticates the communication and attachment of the transaction equipment with and to the docking device.
